(19) United States
(12) Patent Application Publication
(10) Pub. No.: US 2023/0419513 A1
(43) Pub. Date: Dec. 28, 2023

(54) OBJECT DETECTION AND TRACKING IN EXTENDED REALITY DEVICES

(71) Applicant: QUALCOMM INCORPORATED, San Diego, CA (US)

(72) Inventors: Shubhobrata DUTTA CHOUDHURY, New Delhi (IN); Aditya Mishra, Chhatarpur (IN); Sai Krishna Bodapati, Vijaywada (IN); Sudheer Reddy Kesani, Hyderabad (IN)

(21) Appl. No.: 17/849,431

(22) Filed: Jun. 24, 2022

(51) Int. Cl. G06T 7/246; G06F 3/01; G06T 19/00

(52) U.S. Cl. CPC G06T 7/251; G06F 3/017; G06T 19/006; G06F 3/011; G06T 2207/30196

(57) ABSTRACT

Methods, systems, and apparatuses are provided to detect and track an object in an extended reality (XR) environment. For example, a computing device may detect an object in a placement area of a hybrid environment. In response to the detection, the computing device may determine at least one parameter for the object, may register the object based on the at least one parameter, and may track the movement of the object based on the registration. In an additional embodiment, the computing device may capture at least one image of the object, may generate a plurality of data points based on the at least one image, may generate a multi-dimensional model based on the plurality of data points, and may generate a plurality of action points based on the multi-dimensional model. The computing device may track a movement of the object based on the plurality of action points.

### BACKGROUND

### Field of the Disclosure

This disclosure relates generally to extended reality environments and, more specifically, to object detection and tracking in extended reality devices.

### Description of Related Art

Extended Reality (XR) frameworks such as Virtual Reality (VR), Augmented Reality (AR), and Mixed Reality (MR) frameworks may detect objects, such as hands of a user, in a field of view (FOV) of a camera of the respective reality system. The XR frameworks may track the objects as they move throughout their respective environments. For example, in a gaming application, an XR framework may attempt to track a player's hand as the hand is moved throughout the environment.

### SUMMARY

According to one aspect, a method includes receiving image data from a camera. The method also includes detecting, based on the image data, an object in a placement area of a hybrid environment. The hybrid environment includes a real environment and a virtual environment. The method further includes, in response to the detection, determining a value of at least one parameter for the object. The method also includes generating profile data based on the at least one parameter value. The profile data registers the object with a user. Further, the method includes tracking the movement of the object within the hybrid environment based on the profile data.

According to another aspect, a method includes capturing at least one image of an object in a real environment of a hybrid environment. The method also includes generating a plurality of data points for the object based on the at least one image. The method further includes generating a multi-dimensional model of the object based on the plurality of data points. The method also includes generating a plurality of action points based on the multi-dimensional model of the object. Further, the method includes tracking a movement of the object in a virtual environment of the hybrid environment based on the plurality of action points.

According to another aspect, an apparatus comprises a non-transitory, machine-readable storage medium storing instructions, and at least one processor coupled to the non-transitory, machine-readable storage medium. The at least one processor is configured to receive image data from a camera. The at least one processor is also configured to detect, based on the image data, an object in a placement area of a hybrid environment. The hybrid environment includes a real environment and a virtual environment. Further, the at least one processor is configured to, in response to the detection, determine a value of at least one parameter for the object. The at least one processor is also configured to generate profile data based on the at least one parameter value, the profile data. The profile data registers the object with a user. The at least one processor is further configured to track movement of the object within the hybrid environment based on the profile data.

According to another aspect, an apparatus comprises a non-transitory, machine-readable storage medium storing instructions, and at least one processor coupled to the non-transitory, machine-readable storage medium. The at least one processor is configured to capture at least one image of an object in a real environment of a hybrid environment. The at least one processor is also configured to generate a plurality of data points for the object based on the at least one image. Further, the at least one processor is configured to generate a multi-dimensional model of the object based on the plurality of data points. The at least one processor is also configured to generate a plurality of action points based on the multi-dimensional model of the object. The at least one processor is further configured to track a movement of the object in a virtual environment of the hybrid environment based on the plurality of action points.

According to another aspect, a non-transitory, machine-readable storage medium stores instructions that, when executed by at least one processor, causes the at least one processor to perform operations that include receiving image data from a camera. The operations also include detecting, based on the image data, an object in a placement area of a hybrid environment, wherein the hybrid environment comprises a real environment and a virtual environment. Further, the operations include, in response to the detection, determining a value of at least one parameter for the object. The operations also include generating profile data based on the at least one parameter value, the profile data registering the object with a user. The operations further include tracking movement of the object within the hybrid environment based on the profile data.

According to another aspect, a non-transitory, machine-readable storage medium stores instructions that, when executed by at least one processor, causes the at least one processor to perform operations that include capturing at least one image of an object in a real environment of a hybrid environment. The operations also include generating a plurality of data points for the object based on the at least one image. The operations further include generating a multi-dimensional model of the object based on the plurality of data points. The operations also include generating a plurality of action points based on the multi-dimensional model of the object. Further, the operations also include tracking a movement of the object in a virtual environment of the hybrid environment based on the plurality of action points.

According to another aspect, an object detection and tracking device includes a means for receiving image data from a camera. The object detection and tracking device also includes a means for detecting, based on the image data, an object in a placement area of a hybrid environment. The hybrid environment includes a real environment and a virtual environment. The object detection and tracking device also includes a means for, in response to the detection, determining a value of at least one parameter for the object. The object detection and tracking device further include a means for generating profile data based on the at least one parameter value, the profile data registering the object with a user. The object detection and tracking device also includes a means for tracking movement of the object within the hybrid environment based on the profile data.

According to another aspect, an object detection and tracking device includes a means for capturing at least one image of an object in a real environment of a hybrid environment. The object detection and tracking device also includes a means for generating a plurality of data points for the object based on the at least one image. The object detection and tracking device also includes a means for generating a multi-dimensional model of the object based on the plurality of data points. The object detection and tracking device also includes a means for generating a plurality of action points based on the multi-dimensional model of the object. The object detection and tracking device also includes a means for tracking a movement of the object in a virtual environment of the hybrid environment based on the plurality of action points.

### BRIEF DESCRIPTION OF DRAWINGS

FIG. 1 is a block diagram of an exemplary object detection and tracking device, according to some implementations;

FIG. 2A is a diagram illustrating a tracking range in an XR system, according to some implementations;

FIG. 2B is a diagram illustrating a field-of-view (FOV) of a user, according to some implementations;

FIG. 3 is a diagram illustrating insertion of an object into a tracking range of an XR system, according to some implementations;

FIG. 4 is a diagram illustrating a landmarking technique for identifying a hand, according to some implementations;

FIG. 5A is a diagram illustrating palm lines of a hand that may be used to uniquely identify a hand, according to some implementations;

FIG. 5B is a diagram illustrating palm contour mapping that may be used to uniquely identify a hand, according to some implementations;

FIG. 6 is a diagram illustrating a tracking technique in an XR system, according to some implementations;

FIG. 7 is a diagram illustrating a hand tracking technique using 20 different points of a hand, according to some implementations;

FIG. 8A is a diagram illustrating a hand with a covering, according to some implementations;

FIG. 8B is a diagram illustrating a hand with an irregular shape, according to some implementations;

FIG. 9 is a diagram illustrating a hand tracking technique for tracking a hand with an unexpected shape, according to some implementations;

FIG. 10 is a flowchart of an exemplary process for detecting and tracking an object, according to some implementations; and

FIG. 11 is a flowchart of an exemplary process for tracking an object based on a machine learning process, according to some implementations.

### DETAILED DESCRIPTION

While the features, methods, devices, and systems described herein may be embodied in various forms, some exemplary and non-limiting embodiments are shown in the drawings, and are described below. Some of the components described in this disclosure are optional, and some implementations may include additional, different, or fewer components from those expressly described in this disclosure.

Various systems, such as gaming, computer vision, extended reality (XR), augmented reality (AR), virtual reality (VR), medical, and robotics-based applications, rely on receiving input from a user by one or more techniques. These techniques can include the tracking of motion of one or more body parts of a user (e.g., a hand, a fist, fingers of a hand, etc.). For example, imaging devices, such as digital cameras, smartphones, tablet computers, laptop computers, automobiles, or Internet-of-things (IoT) devices (e.g., security cameras, etc.), may capture a user's image, and may reconstruct a 3D image based on one or more body parts of the user. For instance, the imaging devices, may capture an image of a user's hand, such as a gamer's hand, and may reconstruct a 3D image of the user's hand for use within an XR, VR or AR based game, e.g., as part of an avatar.

Existing image processing techniques may allow for the receiving of input from a user through motion of one or objects or body parts of a user. However, these conventional techniques may suffer from several shortcomings, such as properly determining whether a detected object or body part belongs to a user, and determining whether the user intended to send the input using the object or body part. Moreover, these conventional systems may also fail to properly detect a user's gestures using the objects, such as gestures performed with a user's hand or an object the user is holding. For instance, if a user suffers from a deformity in one or both of his hands (such as an irregular shape of a hand, more than five fingers on a hand, fewer than five fingers on a hand, etc.), or if the user is holding an object with fewer than five fingers while intending to provide input, or if the user's hand is wholly, or in part, covered by some material (e.g., a mitten), the XR, VR, or AR system may not successfully detect the user's hand, and may be unable to recognize one or more gestures that the user may intend for the XR, VR, or AR system to detect.

In some implementations, an object detection and tracking device may include one or more optical elements, such as a camera, one or more motion sensors, a thermal camera, and a sensitive microphone for detecting sounds based on movements, and may detect one or more objects or body parts of the user within a virtual environment to identify (e.g., determine) input gestures made by the user. In some implementations, the object detection and tracking device may detect an object in a field-of-view (FOV) of a camera, and determine that the object corresponds to a particular user. For instance, the object detection and tracking device may determine that an object corresponds to a user and is being used to provide input gestures. The object detection and tracking device may, additionally or alternatively, determine that the object does not correspond to the user and thus will not be used to provide input gestures.

In one implementation, the object detection and tracking device may include one or more processors that execute instructions stored in a memory of the object detection and tracking device. The one or more processors may include, for example, a camera processor, a central processing unit (CPU), a graphical processing unit (GPU), a digital signal processor (DSP), or a neural processing unit (NPU). The object detection and tracking device may execute the instructions to detect an object, such as a hand of a user, based on one or more parameter values. The parameter values may correspond to, for example, an angle of insertion of the object into a predetermined window within a FOV of the user within the virtual environment. The object detection and tracking device may also execute the instructions to detect that the object corresponds to the user, and may track the object to recognize input gestures from the user. For example, the object detection and tracking device may detect an object within the predetermined window, determine that the object corresponds to the user, and may track the object over the FOV of the user. Based on tracking movement of the object, the object detection and tracking device may determine one or more input gestures from the user.

In another implementation, the object detection and tracking device may include one or more processors that execute instructions stored in a memory of the object detection and tracking device to detect an object of the user, such as a hand, based on a unique profile of the user. For instance, the unique profile of the user may include data characterizing one or more of a shape of a user's hand, palm lines on the user's hand, palm-contours, sizes of the user's fingernails, shapes of the user's fingernails, the object's color, a multi-point outline of the user's hand, and one or more identification marks on the object. The object detection and tracking device may execute the instructions to track the object based on the profile of the user. For instance, the object detection and tracking device may execute the instructions to detect one or more input gestures from the user based on the profile of the user.

In some implementations, the object detection and tracking device may include one or more processors that execute one or more trained machine learning processes to detect an object of a user, such as a user's hand, for tracking and receiving one or more gesture inputs. The trained machine learning processes may include, for example, a trained neural network process (e.g., a trained convolutional neural network (CNN) process), a trained deep learning process, a trained decision tree process, a trained support vector machine process, or any other suitable trained machine learning process. For instance, during initialization, the object detection and tracking device may prompt the user to select an object detected by a camera or sensor of the object detection and tracking device as an object to be utilized for detecting gesture inputs for the user. The object detection and tracking device may apply the trained machine learning process to image data characterizing the selected object to generate a plurality of data points for the object, and a multi-dimensional model of the selected object. Further, the object detection and tracking device may apply the trained machine learning process to the multi-dimensional model of the object to estimate action points. For instance, the action points may be anticipated points in a 3-D space of a virtual environment that may move when making certain gestures. In some instances, the object detection and tracking device may implement a training mode for the machine learning process during which the machine learning process may iteratively alter the action points in the 3-D space for respective gestures. For example, the object detection and tracking device may determine a gesture based on generated action points, and may request and receive a validation from the user to confirm whether the determined gesture is correct.

In some implementations, and based on the execution of instructions stored in non-volatile memory, the one or more processors may apply a machine learning process to a multi-dimensional model of the object to generate a look-up table. The look-up table may include a list of gestures and a sequence of tracking points in a 3-D space that the object may be expected to span during a gesture. The tracking points may include, for example, x, y, z coordinates for each of the tracking points in the 3-D space.

When the training process completes, the one or more processors may store values and sequences of the tracking points and the corresponding gestures as look-up tables (e.g., each look-up table corresponding to a unique object/hand of the user) in a memory device of the object detection and tracking device. The look-up table corresponding to the object may enable the one or more processors to detect and identify a gesture(s) made by the object as movement of the object is tracked (e.g., during a gesture input).

Among other advantages, the embodiments described herein may provide for more accurate object (e.g., hand) detection abilities for XR, VR or AR systems. For instance, the embodiments may more accurately identify which object corresponds to a user, and which object in a FOV of the user may be a foreign or unintended object which is to be ignored. Further, the embodiments as described herein may provide greater flexibility to a user for utilizing an irregularly shaped object for receiving input. The embodiments may especially be helpful and enabling to users in physically challenged situations, such as those with biological defects in one or both hands. The embodiments may further allow a user to engage in multi-tasking (e.g., holding one or more objects in their hands, engaging one or more fingers with other gadgets such as a fitness tracker, smart watch etc.) while making gestures that the object detection and tracking device can successfully detect and track. Further, the embodiments may be employed across a variety of applications, such as in gaming, computer vision, AR, VR, medical, biometric, and robotics applications, among others. Persons of ordinary skill in the art having the benefit of these disclosures would recognize these and other benefits as well.

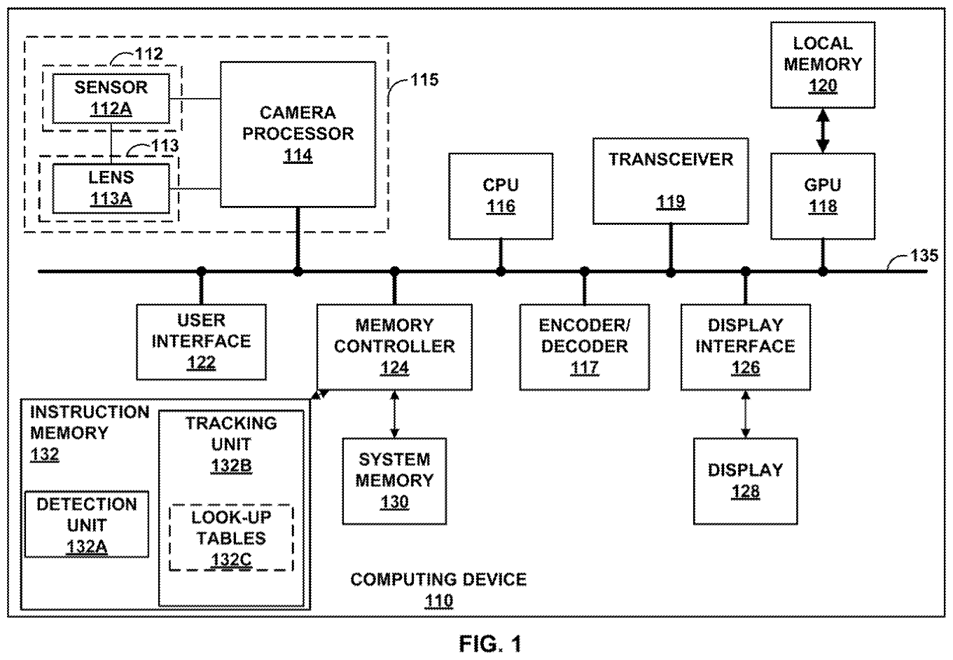

FIG. 1 is a block diagram of an exemplary object detection and tracking device 100. The functions of object detection and tracking device 100 may be implemented in one or more processors, one or more field-programmable gate arrays (FPGAs), one or more application-specific integrated circuits (ASICs), one or more state machines, digital circuitry, any other suitable circuitry, or any suitable hardware. Object detection and tracking device 100 may perform one or more of the exemplary functions and processes described in this disclosure. Examples of object detection and tracking device 100 include, but are not limited to, a computer (e.g., a gaming console, a personal computer, a desktop computer, or a laptop computer), a mobile device such as a tablet computer, a wireless communication device (such as, e.g., a mobile telephone, a cellular telephone, etc.), a digital camera, a digital video recorder, a handheld device, such as a portable video game device or a personal digital assistant (PDA), a drone device, a virtual reality device (e.g., a virtual reality headset), an augmented reality device (e.g., augmented reality glasses), a virtual reality device (e.g., virtual reality headset), an extended reality device, or any device that may include one or more cameras.

As illustrated in the example of FIG. 1, object detection and tracking device 100 may include one or more image sensors 112, such as image sensor 112A, lens 113A, and one or more camera processors, such as camera processor 114. In some instances, the camera processor 114 may be an image signal processor (ISP) that employs various image processing algorithms to process image data (e.g., as captured by corresponding ones of these lenses and sensors). For example, the camera processor 114 may include an image front end (IFE) and/or an image processing engine (IPE) as part of a processing pipeline. Further, a camera 115 may refer to a collective device including one or more image sensors 112, one or more lens 113, and one or more camera processors 114.

Object detection and tracking device 100 may further include a central processing unit (CPU) 116, an encoder/decoder 117, a graphics processing unit (GPU) 118, a local memory 120 of GPU 118, a user interface 122, a memory controller 124 that provides access to system memory 130 and to instruction memory 132, and a display interface 126 that outputs signals that causes graphical data to be displayed on a display 128.

In some examples, one of image sensors 112 may be allocated for each of lenses 113. Further, in some examples, one or more of image sensors 112 may be allocated to a corresponding one of lenses 113 of a respective, and different, lens type (e.g., a wide lens, ultra-wide lens, telephoto lens, and/or periscope lens, etc.). For instance, lenses 113 may include a wide lens, and a corresponding one of image sensors 112 having a first size (e.g., 108 MP) may be allocated to the wide lens. In other instance, lenses 113 may include an ultra-wide lens, and a corresponding one of image sensors 112 having a second, and different, size (e.g., 16 MP) may be allocated to the ultra-wide lens. In another instance, lenses 113 may include a telephoto lens, and a corresponding one of image sensors 112 having a third size (e.g., 12 MP) may be allocated to the telephoto lens.

In an illustrative example, a single object detection and tracking device 100 may include two or more cameras (e.g., two or more of camera 115). Further, in some examples, a single image sensor, e.g., image sensor 112A, may be allocated to multiple ones of lenses 113. Additionally, or alternatively, each of image sensors 112 may be allocated to a different one of lenses 113, e.g., to provide multiple cameras to object detection and tracking device 100.

In some examples, not illustrated in FIG. 1, object detection and tracking device 100 may include multiple cameras (e.g., a mobile phone having one or more front-facing cameras and one or more rear-facing cameras). For instance, object detection and tracking device 100 may include a first camera, such as camera 115 that includes a 16 MP image sensor, a second camera that includes a 108 MP image sensor, and a third camera that includes a 12 MP image sensor.

Each of the image sensors 112, including image sensor 112A, may represent an image sensor that includes processing circuitry, an array of pixel sensors (e.g., pixels) for capturing representations of light, memory, an adjustable lens (such as lens 113), and an actuator to adjust the lens. By way of example, image sensor 112A may be associated with, and may capture images through, a corresponding one of lenses 113, such as lens 113A. In other examples, additional, or alternate, ones of image sensors 112 may be associated with, and capture images through, corresponding additional ones of lenses 113.

Image sensors 112 may also include a subset of two or more different image sensors operating in conjunction with one another that detect motion of an object/hand. For example, image sensors 112 may include two different “color” pixel sensors operating in conjunction with one another. The different color pixel sensors may support different binning types and/or binning levels, and although operating in conjunction with one another, the different color pixel sensors may each operate with respect to a particular range of zoom levels.

Additionally, in some instances, object detection and tracking device 100 may receive user input via user interface 122, and a response to the received user input, CPU 116 and/or camera processor 114 may activate respective ones of lenses 113, or combinations of lenses 113. For example, the received user input may correspond to an affirmation that the object/hand in view of the lens 113A is the object/hand of the user which should be tracked for input gestures. In some instances, the user input via user interface 122 may be an affirmation that the object detection and tracking device 100 has identified the correct gesture during the machine learning process (as described above).

Although the various components of object detection and tracking device 100 are illustrated as separate components, in some examples, the components may be combined to form a system on chip (SoC). As an example, instruction memory 132, CPU 116, GPU 118, and display interface 126 may be implemented on a common integrated circuit (IC) chip. In some examples, one or more of instruction memory 132, CPU 116, GPU 118, and display interface 126 may be implemented in separate IC chips. Various other permutations and combinations are possible, and the techniques of this disclosure should not be considered limited to the example of FIG. 1.

System memory 130 may store program modules and/or instructions and/or data that are accessible by camera processor 114, CPU 116, and GPU 118. For example, system memory 130 may store user applications (e.g., instructions for the camera application) and resulting images from camera processor 114. System memory 130 may additionally store information for use by and/or generated by other components of object detection and tracking device 100. For example, system memory 130 may act as a device memory for camera processor 114. System memory 130 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media, cloud-based storage medium, or an optical storage media.

Camera processor 114 may store data to, and read data from, system memory 130. For example, camera processor 114 may store a working set of instructions to system memory 130, such as instructions loaded from instruction memory 132. Camera processor 114 may also use system memory 130 to store dynamic data created during the operation of object detection and tracking device 100.

Similarly, GPU 118 may store data to, and read data from, local memory 120. For example, GPU 118 may store a working set of instructions to local memory 120, such as instructions loaded from instruction memory 132. GPU 118 may also use local memory 120 to store dynamic data created during the operation of object detection and tracking device 100. Examples of local memory 120 include one or more volatile or non-volatile memories or storage devices, such as RAM, SRAM, DRAM, EPROM, EEPROM, flash memory, a magnetic data media, a cloud-based storage medium, or an optical storage media.

Instruction memory 132 may store instructions that may be accessed (e.g., read) and executed by one or more of camera processor 114, CPU 116, and GPU 118. For example, instruction memory 132 may store instructions that, when executed by one or more of camera processor 114, CPU 116, and GPU 118, cause one or more of camera processor 114, CPU 116, and GPU 118 to perform one or more of the operations described herein. For instance, instruction memory 132 can include a detection unit 132A that can include instructions that, when executed by one or more of camera processor 114, CPU 116, and GPU 118, cause camera processor 114, CPU 116, and GPU 118 to detect an object/hand of the user as described in different embodiments. Instruction memory 132 can also include tracking unit 132B that can include instructions that, when executed by one or more of camera processor 114, CPU 116, and GPU 118, cause camera processor 114, CPU 116, and GPU 118 to track the movement of the object/hand as described in different embodiments. In an optional implementation, the tracking unit 132B may include look-up tables 132C, that may store for a specific object/hand, a sequence(s) of tracking points and gesture(s) corresponding to the sequence(s) of tracking points. As described herein, the look-up tables 132C may allow identification of a gesture for an object/hand based on tracking points spanned by the object/hand in the gesture. Further, the tracking unit 132B may include instructions that, when executed by one or more of camera processor 114, CPU 116, and GPU 118, cause camera processor 114, CPU 116, and GPU 118 to execute a machine learning process as described herein.

Instruction memory 132 may also store instructions that, when executed by one or more of camera processor 114, CPU 116, and GPU 118, cause one or more of camera processor 114, CPU 116, and GPU 118 to perform image processing operations, generate a plurality of data points for an object/hand, generate a multi-dimensional model of the object/hand, and generate a plurality of action points based on the multi-dimensional model of the object/hand as described herein.

The various components of object detection and tracking device 100, as illustrated in FIG. 1, may be configured to communicate with each other across bus 135. Bus 135 may include any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus), or another type of bus or device interconnect. It is to be appreciated that the specific configuration of components and communication interfaces between the different components shown in FIG. 1 is merely exemplary, and other configurations of the components, and/or other image processing systems with the same or different components, may be configured to implement the operations and processes of this disclosure.

Camera processor 114 may be configured to receive image frames (e.g., pixel data, image data) from image sensors 112, and process the image frames to generate image and/or video content. For example, image sensor 112A may be configured to capture individual frames, frame bursts, frame sequences for generating video content, photo stills captured while recording video, image previews, or motion photos from before and/or after capture of an input gesture by the user. CPU 116, GPU 118, camera processor 114, or some other circuitry may be configured to process the image and/or video content captured by image sensor 112A into images or video for display on display 128. In an illustrative example, CPU 116 may cause image sensor 112A to capture image frames, and may receive pixel data from image sensor 112A. In the context of this disclosure, image frames may generally refer to frames of data for a still image or frames of video data or combinations thereof, such as with motion photos. Camera processor 114 may receive, from image sensors 112, pixel data of the image frames in any suitable format. For instance, the pixel data may be formatted according to a color format such as RGB, YCbCr, or YUV.

In some examples, camera processor 114 may include an image signal processor (ISP). For instance, camera processor 114 may include an ISP that receives signals from image sensors 112, converts the received signals to image pixels, and provides the pixel values to camera processor 114. Additionally, camera processor 114 may be configured to perform various operations on image data captured by image sensors 112, including auto gain, auto white balance, color correction, or any other image processing operations.

Memory controller 124 may be communicatively coupled to system memory 130 and to instruction memory 132. Memory controller 124 may facilitate the transfer of data going into and out of system memory 130 and/or instruction memory 132. For example, memory controller 124 may receive memory read and write commands, such as from camera processor 114, CPU 116, or GPU 118, and service such commands to provide memory services to system memory 130 and/or instruction memory 132. Although memory controller 124 is illustrated in the example of FIG. 1 as being separate from both CPU 116 and system memory 130, in other examples, some or all of the functionality of memory controller 124 with respect to servicing system memory 130 may be implemented on one or both of CPU 116 and system memory 130. Likewise, some or all of the functionality of memory controller 124 with respect to servicing instruction memory 132 may be implemented on one or both of CPU 116 and instruction memory 132.

Camera processor 114 may also be configured, by executed instructions, to analyze image pixel data and store resulting images (e.g., pixel values for each of the image pixels) to system memory 130 via memory controller 124. GPU 118 or some other processing unit, including camera processor 114 itself, may perform operations to detect an object in a placement area, registering the object/hand, generating a plurality of data points for the object/hand based on an image of the object/hand, generating a multi-dimensional model of the object/hand based on the plurality of data points, generating a plurality of action points based on the multi-dimensional model, and tracking the movement of the object/hand in a virtual environment based on the plurality of action points.

In addition, object detection and tracking device 100 may include a video encoder and/or video decoder 117, either of which may be integrated as part of a combined video encoder/decoder (CODEC). Encoder/decoder 117 may include a video coder that encodes video captured by one or more camera(s) 115 or a decoder that decodes compressed or encoded video data. In some instances, CPU 116 may be configured to encode and/or decode video data using encoder/decoder 117.

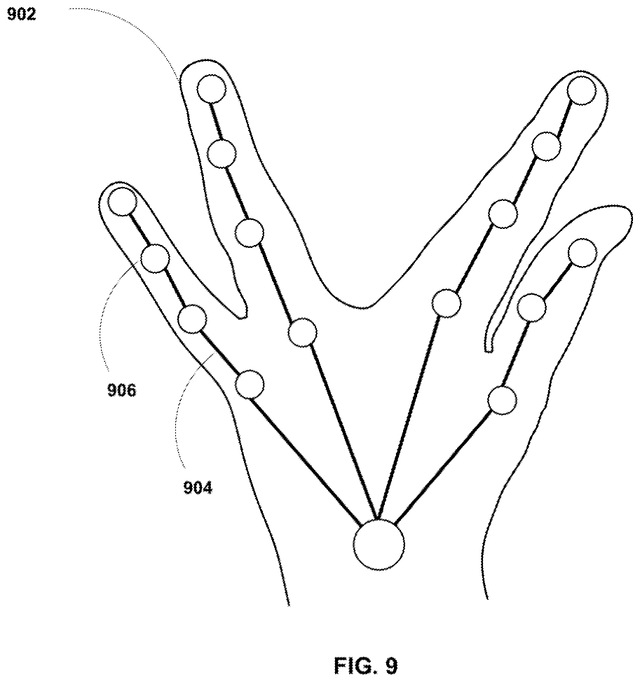

CPU 116 may comprise a general-purpose or a special-purpose processor that controls operation of object detection and tracking device 100. A user may provide input to object detection and tracking device 100 to cause CPU 116 to execute one or more software applications. The software applications executed by CPU 116 may include, for example, a camera application, a graphics editing application, a media player application, a video game application, a graphical user interface application or another program. For example, and upon execution by CPU 116, a camera application may allow control of various settings of camera 115, e.g., via input provided to object detection and tracking device 100 via user interface 122. Examples of user interface 122 include, but are not limited to, a pressure-sensitive touchscreen unit, a keyboard, a mouse, or an audio input device, such as a microphone. For example, user interface 122 may receive input from the user to validate an object to be tracked to for input gestures, or validate the gestures recognized during machine learning process (as described above, and with reference to FIG. 9 description below).

By way of example, the executed camera application may cause CPU 116 to generate content that is displayed on display 128 and/or in a virtual environment of the hybrid environment of an AR, VR or XR system. For instance, display 128 or a projection in the virtual environment may display information, such as an image insertion guide for indicating to the user a direction and/or an angle of insertion of the object/hand for detection by the object detection and tracking device 100. An executed hand detection and tracking application stored in the system memory 130 and/or the instruction memory 132 (not shown in FIG. 1 for simplification) may also cause CPU 116 to instruct camera processor 114 to process the images captured by sensor 112A in a pre-defined manner. For example, CPU 116 may instruct camera processor 114 to perform a zoom operation, or increase white balance on the images captured by one or more of sensors 112, e.g., in response to a identifying that the hand/object is small, or the hand/object is in a low-light environment, etc.

As described herein, one or more of CPU 116 and GPU 118 may perform operations that apply a trained machine learning process to generate or update look-up tables 132C.

In some examples, the one or more of CPU 116 and GPU 118 cause the output data to be displayed on display 128. In some examples, the object detection and tracking device 100 transmits, via transceiver 119, the output data to a computing device, such as a server or a user's handheld device (e.g., cellphone). For example, the object detection and tracking device 100 may transmit a message to another computing device, such as a verified user's handheld device, or a projection device simulating a virtual environment based on the output data.

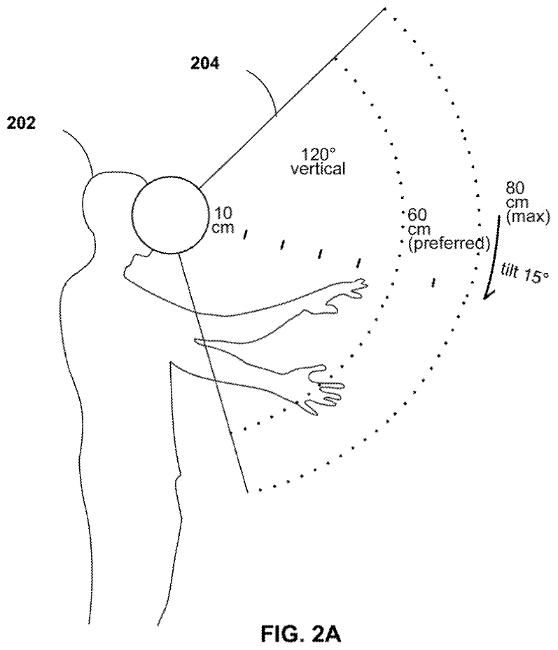

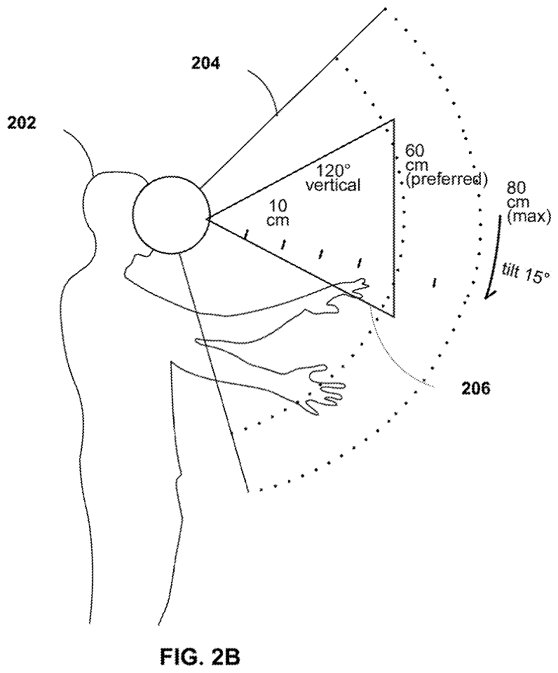

FIG. 2A is a diagram illustrating a tracking range in an XR system that includes, for example, the object detection and tracking device 100. FIG. 2A includes a user 202 having an FOV 204. The FOV 204 of the user 202 may have an angular spread of 120 degrees as shown in FIG. 2A. Typically the FOV 204 may be an area that a VR, AR, or XR system may track (e.g., using one or more cameras 115) for input gestures by the user 202. For instance, the VR, AR or XR system may track objects, such as a user's hand, within FOV 204. FOV 204 may extend from a first radius from the user to a second radius from the user. For instance, and as shown in FIG. 2A, the FOV 204 may extend from a radius of approximately 10 cm from the eyes of the user 202 to a radius of 60-80 centimeters from the user. Although FIG. 2A illustrates the hands of the user 202 in the FOV 204, multiple hands of various users (e.g., a foreign hand, which may be a hand of a person other than the user 202) may be present in the FOV 204. The VR, AR, or XR system may detect hands that are inserted into FOV 204, may determine whether each hand is associated with a corresponding user, and may track hands associated with corresponding users. For example, the VR, AR or XR system may detect input gestures made with the detected hands from each of the users, such as user 202.

FIG. 2B is a diagram illustrating a FOV 204 of a user with a placement area 206 for initialization of object detection and tracking, in accordance with some embodiments. FIG. 2B includes the user 202 having the FOV 204 (as described above with reference to FIG. 2A), and a placement area 206 within the FOV 204. In one implementation, the object detection and tracking device 100 may generate and display, within a virtual environment, a highlight of the placement area 206 to the user 202 during initialization of the object detection and tracking process. For example, the CPU 116 may execute instructions stored in the detection unit 132A to generate a request for the user 202 to insert an object, such as the user's hand, into the placement area 206. The display unit 208 may cause the placement area 206 to be highlighted and displayed to the user 202 in the virtual environment (e.g., as seen by the user 202 through VR goggles). At initialization, the object detection and tracking device 100 may detect the object present in the placement area 206 as an object of the user 202 to be tracked for recognizing input gestures from the user 202.

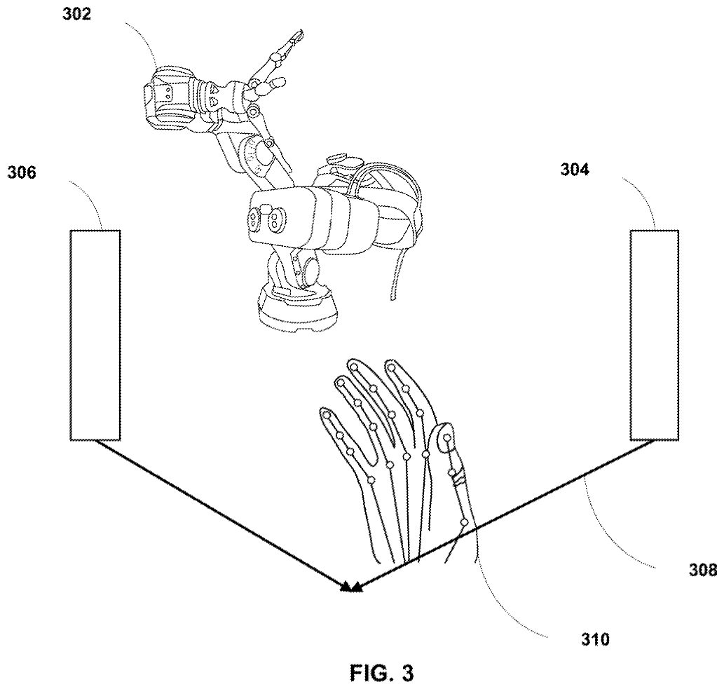

FIG. 3 is a diagram illustrating the insertion of an object into a tracking range of an XR system utilizing the object detection and tracking device 100 of FIG. 1. FIG. 3 includes a placement area 308 (similar to the placement area 206, as described above with reference to FIG. 2B), highlighting to the user 202 an angle of insertion and a direction of insertion of a hand 310 of the user 202 into the placement area 308. FIG. 3 includes a projection device 302 (e.g., a projection device of the object detection and tracking device 100) that may project the placement area 308 bounded by boundaries 304 and 306 of the placement area 308, for detection of the hand 310. The projection device 302 may highlight to the user an angle of insertion into the placement area 308, through which the user may insert the hand 310 for detection by the object detection and tracking device 100. In some examples, the projection device 302 may generate and display, within the virtual environment, an image identifying a direction of insertion into the placement area 308 for detection of the hand 310.

In some examples, the object detection and tracking device 100 may determine whether an angle of insertion of the hand 310 is within a predetermined range, and may generate profile data identifying the hand 310 as the hand of a user based on the determination. For example, the predetermined range may be a range of values of angles based on the horizon of vision of the user 202. When the object detection and tracking device 100 determines that a detected angle of insertion of hand 310 is within the predetermined range of values, the object detection and tracking device 100 may register the hand 310 as an object to be tracked for the user. Similarly, the object detection and tracking device 100 may determine that a direction of insertion into the placement area 308 is an appropriate direction (e.g., bottom to up), and the object detection and tracking device 100 may register the hand 310 as the object to be tracked for the user.

As another example, the object detection and tracking device 100 may determine the angle of insertion of the hand 310 is not within the predetermined range of values, and may not associate the hand 310 with the user. Similarly, the object detection and tracking device 100 may determine that a direction of insertion into the placement area 308 is the not the appropriate direction (e.g., top to bottom), and may not associate the hand 310 with the user. As such, the object detection and tracking device 100 may not register the hand 310 as an object to be tracked. In one implementation, the object detection and tracking device 100 may request the user 202 to re-enter the hand 310 at a suggested angle and/or direction. For example, the object detection and tracking device 100 may provide visual cues (e.g., providing an insertion guidance image that identifies one or more insertion angles for inserting the hand/object 310 into the placement area 308) through a projection in or near the placement area 308, that indicates to the user 202 an angle of insertion and/or a direction of insertion through which the user 202 may insert the hand 310 to successfully register the hand 310 as a hand of the user 202 with the XR system.

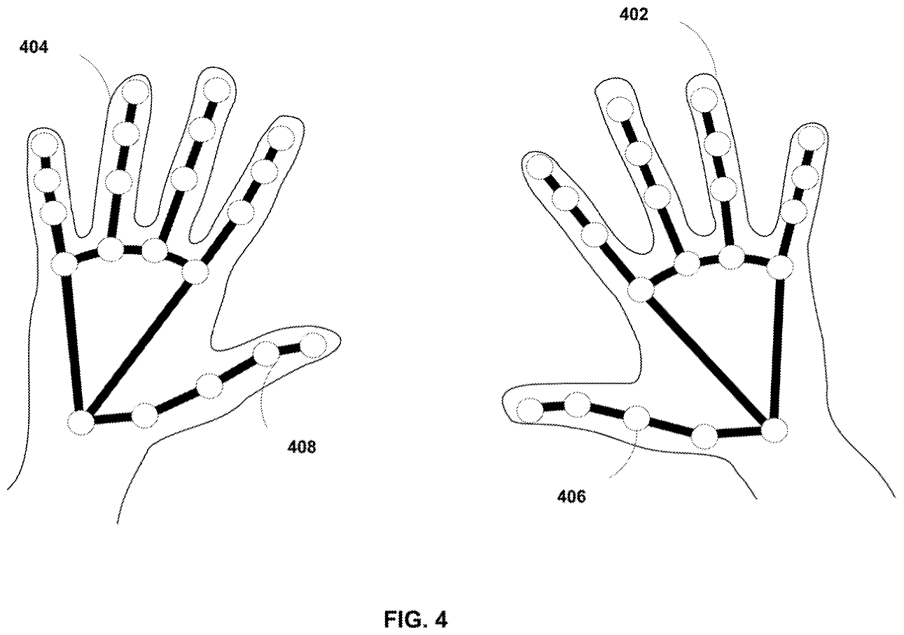

FIG. 4 is a diagram illustrating a landmarking technique for identifying a hand. FIG. 4 includes hands 402 and 404 each including multiple landmarking points 406 and 408, respectively. The object detection and tracking device 100 may uniquely identify the hand of the user 202 as described herein based on the landmarking points 406 and 408. For instance, each of the landmarking points 406 and 408 may be a set of points that uniquely describe the geometry of the hands 402 and 404 of the user 202, respectively. The object detection and tracking device 100 may detect and identify the hands 402 and 404 based on hand-line graphing maps. For example, the object detection and tracking device 100 may compare the landmarking points 406 and 408 to a set of points within a hand-line graphing map stored in memory (e.g., system memory 130 and/or instruction memory 132) of the object detection and tracking device 100. On detecting a successful match, the object detection and tracking device 100 may find that a hand inserted in the placement area (e.g., the placement area 308 as described above with reference to FIG. 3) is the hand of the user 202, and register the detected object as an object of the user 202 for tracking and receiving input gestures from the user 202. For instance, the object detection and tracking device 100 may generate profile data that associates the detected hand with the user, and may store the profile data within system memory 132.

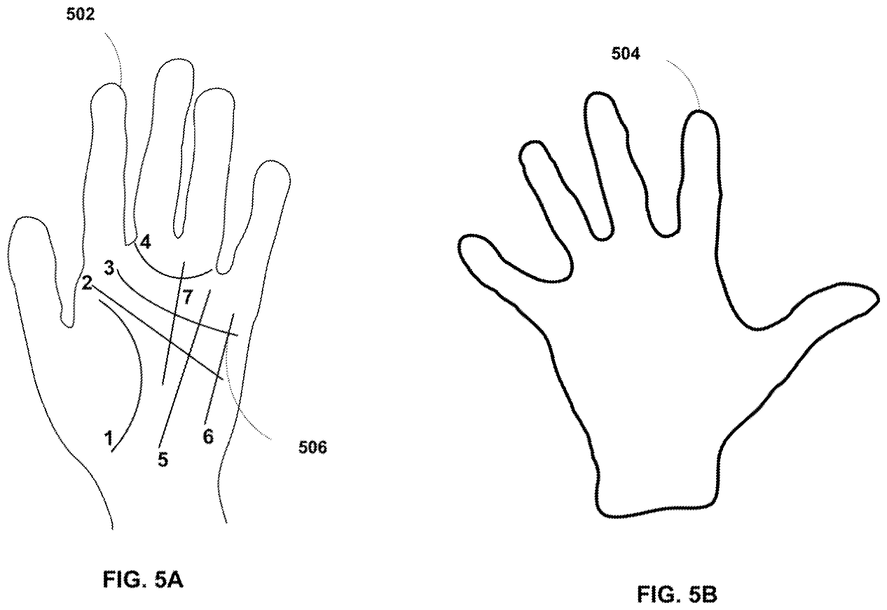

FIG. 5A is a diagram illustrating palm lines of a hand that may be used to uniquely identify a hand. FIG. 5A includes palm lines 506 (lines 1-7) as shown in FIG. 5A. The object detection and tracking device 100 may uniquely identify and detect a hand with the palm-lines as shown in FIG. 5A based on comparing the data characterizing the palm lines 506 with another set of data characterizing palm lines and stored in memory (e.g., the system memory 130 and/or the instruction memory 132, as described above with reference to FIG. 1) of the object detection and tracking device 100. Upon determining a successful match, the object detection and tracking device 100 may determine the hand inserted in the placement area 308 as the hand of the user 202, and may track movement of the hand such as to determine gestures of the user 202. The object detection and tracking device 100 is not limited to utilizing the palm lines 506 as described above for determining a successful match. In some implementations, the object detection and tracking device 100 may utilize other unique features of the hand(s) of the user 202, such as palm contours, hand shape (e.g., unique geometrical shape), size of fingernails, shape of fingernails, color of the hand, multi-point hand outline geometry, and/or one or more identification marks on the hand(s) of the user 202 to uniquely identify the hand as the hand of the user 202. Once detected, the object detection and tracking device 100 may generate profile data, where the profile data registers the hand as the hand of the user 202 with the XR system. The object detection and tracking device 100 may track the motion of the hand for receiving input gestures from the user 202 based on the profile data.

FIG. 5B is a diagram illustrating palm contour mapping of a hand that may be used to uniquely identify a hand, such as a hand inserted into placement area 308. FIG. 5B includes palm contour image data 504 as shown in FIG. 5B. Palm-contour image data 504 may be based on an image captured by a camera 115 of object detection and tracking device 100. The object detection and tracking device 100 may uniquely identify and detect a hand with a palm contour characterized by palm-contour image data 504. For instance, object detection and tracking device 100 may compare the palm contour image data 504 with palm contour data stored in the memory (e.g., the system memory 130 and/or the instruction memory 132, as described above with reference to FIG. 1) of the object detection and tracking device 100 to determine whether palm contours match. In some instances, system memory 132 stores palm contour data for a plurality of users. The palm contour data may identify and characterize a plurality of pixel locations along a contour of a hand captured within an image. The object detection and tracking device 100 may perform operations to determine whether any of the palm contour data for the users matches a contour of palm contour image data 504 to identify the user. Upon determining a successful match, the object detection and tracking device 100 may determine the hand inserted in a placement area 308 as the hand of the user 202, and may detect and track gestures of the hand as the input gestures of the user 202.

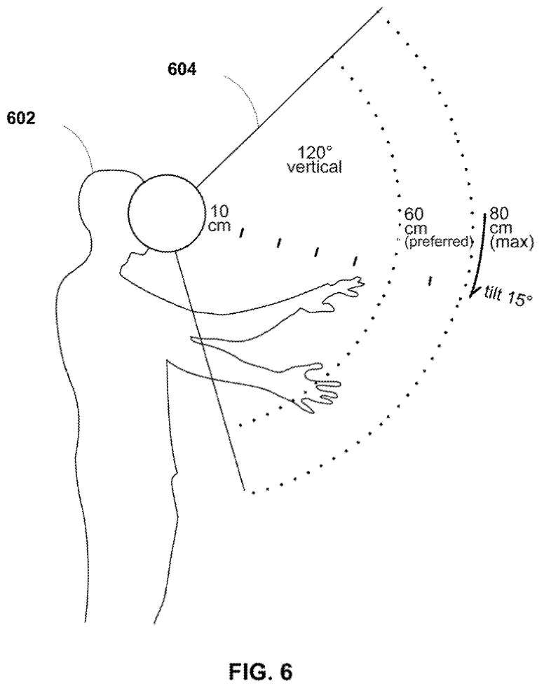

FIG. 6 is a diagram illustrating a tracking technique in an XR system. FIG. 6 includes a user 602 having an FOV 604. The FOV 604 of the user 602 may have an angular spread of a number of degrees, such as 120 degrees as shown in FIG. 6. Typically the FOV 604 may be an area within a real environment that a VR, AR, or XR system may track for input gestures by the user 602. As shown in FIG. 6, the FOV 604 may extend from a radius of approximately 10 cm from the eyes of the user 602, to a radius from the user in the range of 60-80 centimeters. FIG. 6 only represents the hands of the user 602 in the FOV 604, however it may be challenging for a conventional VR, AR or XR system to detect and track the hand(s) of the user 602 when the hand(s) may be of an irregular or unexpected shape, or covered with a material, such as clothing, thereby making it difficult to identify the hand/object that should be tracked by the VR, AR or XR system for receiving input gestures from the user 602. As described herein, however, object detection and tracking device 100 may employ a hand tracking technique to detect hands or objects of irregular shape.

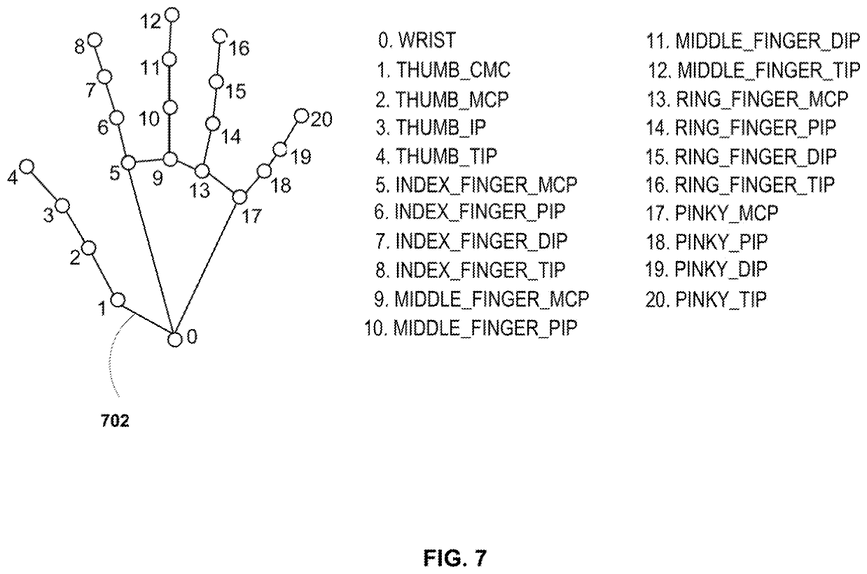

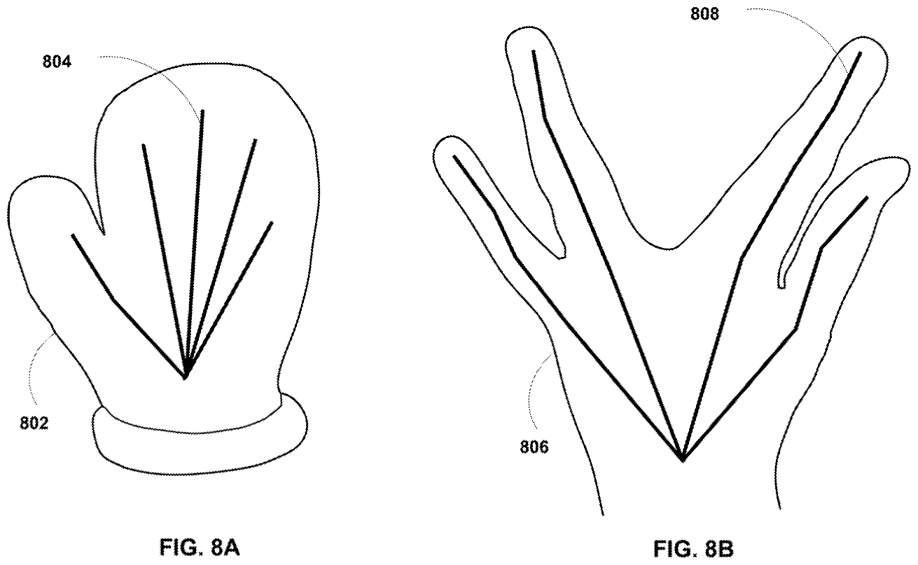

For instance, FIG. 7 is a diagram illustrating a hand tracking map using 20 different points of a hand. FIG. 7 includes a 20 point diagram 702 of the hand of a user, with each of the 20 points described for their specific locations on a regular hand. However, in an instance when the shape of a user's hand is irregular (e.g., the user has four fingers instead of five), or the user has a covering over the hand, each of the 20 points shown in FIG. 7A may not be present or identifiable. Such examples of hands are described below with reference to FIGS. 8A & 8B.

For instance, FIG. 8A is a diagram illustrating a hand with a covering. FIG. 8A includes a hand 802 with a mitten covering the hand, and contour lines 804 indicate the shape of the hand 802. As compared to FIG. 7, the 20 point model for identification and detection of the hand of the user may not be usable for detecting or tracking the motion of the hand 802 for recognition of input gestures, at least because the hand 802 may not map to all of the 20 points, or a sufficient number of points, for detecting and tracking the hand 802 using the 20 point technique.

FIG. 8B is a diagram illustrating a hand with an irregular shape. FIG. 8B includes a hand 806 with an irregular shape (such as a missing middle finger), and contour lines 808 describe the shape of the hand 806. As compared to FIG. 7, the 20 point model for identification and detection of the hand of the user may not be usable for detecting or tracking the motion of the hand 806 for recognition of input gestures, at least because the hand 802 may not map to all of the 20 points, or a sufficient number of points, for detecting and tracking the hand 802 using the 20 point technique. FIG. 9, however, illustrates an initialization start technique that the object detection and tracking device 100 may utilize to detect unexpected shapes and sizes of an object by seeking an acknowledgement from a user (e.g., the user 202) through ground truth initialization.

Specifically, FIG. 9 is a diagram illustrating a hand tracking technique for tracking a hand with an unexpected or irregular shape. FIG. 9 includes a hand 902 with contour lines 904. The object detection and tracking device 100, upon detecting a hand with a covering (e.g., as shown in FIG. 8A), or a hand with an irregular shape (e.g., as shown in FIG. 8B), or an object (e.g., an artificial limb), may generate a plurality of data points 906 for the hand 902 based on an image of the hand 902. The object detection and tracking device 100 may also generate a multi-dimensional model (e.g., a 3-D model) of the hand 902 based on the plurality of data points 906. For example, the object detection and tracking device 100 may capture one or more images of the hand 902 in a real environment of a hybrid environment of an XR system, and plot the data points 906 in a 3-D space to generate a multi-dimensional model for the hand 902. The multi-dimensional model may be, for example, a 3D model of the hand 902. The object detection and tracking device 100 may also generate a plurality of action points based on the multi-dimensional model of the hand 902 and a detected gesture. The object detection and tracking device 100 may further determine a plurality of tracking points, which may be points in 3-D space that the hand 902 is expected to span across when making a gesture, and may store the tracking points in a look-up table (e.g., the look-up tables 132C as described above with reference to FIG. 1) that is specific to the hand 902. Each sequence of tracking points in the look-up table may correspond to a gesture. The object detection and tracking device 100 may utilize the look-up table to determine a gesture for the hand 902 when the hand 902 makes a movement in the 3-D space. The detailed steps of this initialization technique for hand/object detection, registration, and tracking are as described below.

To begin the initialization process, the object detection and tracking device 100 may generate a first request for a placement of the object in a hybrid environment that includes a real environment, and a virtual environment. For example, the object detection and tracking device 100 may indicate to a user the first request in a virtual environment of the XR system by generating and displaying an image that highlights a placement area (e.g., the placement area 308 as described above with reference to FIG. 3) to request the user to place an object, such as a hand, in the placement area. On detecting that the user may have placed an object in the placement area, the object detection and tracking device 100 may generate a second request for an acknowledgement from the user that the object is a hand of the user. For example, the object detection and tracking device 100 may seek validation from the user that the object placed in the placement area is the object that the user intends to use for providing gesture inputs. The object detection and tracking device 100 may display the second request within the virtual environment of the XR device, e.g., through a projection in front of the user. Upon receiving a response from the user confirming that the identified object is the object that the user intends to use for providing input gestures, the object detection and tracking device 100 may generate a plurality of image data points for the object. For instance, the plurality of image data points may be similar to the data points 906 as shown in FIG. 9. The number of data points in the plurality of image data points may be any number, including less than 20, more than 20, or equal to 20. Further, the plurality of image data points may differ from user to user based on a shape of the object that each user registers.

Based on the plurality of image data points, the object detection and tracking device 100 may determine a plurality of action points, and may store the plurality of action points in a memory. The plurality of action points may be significant points that are mobile enough in an object, such as a hand, to create gestures. For example, the plurality of action points may correspond to joints or other points where the object or hand can bend (e.g., the action points may be points in a 3-D model of the hand that are expected to be active/moving in a certain manner for a specific gesture). The object detection and tracking device 100 may apply a trained machine learning process, such as a trained neural network, to the plurality of data points to determine the plurality of action points. For instance, a neural network may be trained using supervised learning based on elements of image data characterizing hands and corresponding action points. The object detection and tracking device 100 may execute the trained neural network to ingest the plurality of data points and output the plurality of action points.

Based on the plurality of action points and the captured image, the object detection and tracking device 100 may determine a gesture of the user. For instance, the object detection and tracking device 100 may capture an image of an object in an FOV 604, and may adapt the plurality of action points to the image of the object to generate tracking points for the object. For example, the tracking points may be points in a 3-D space that a hand 902 is expected to span when making a gesture, such as FOV 604. In some instances, the object detection and tracking device 100 may determine the plurality of action points for multiple captured images, and may determine the gesture based on tracking points generated for each of the captured images. For instance, the object detection and tracking device 100 may capture a second image of the object in the FOV 604, and may adapt the plurality of action points to an object in the second image to generate additional tracking points. The object detection and tracking device 100 may determine the gesture based on the tracking points and the additional tracking points (e.g., the gesture may be a movement of the object from one location in the virtual environment to another). The object detection and tracking device 100 may utilize such sequence of tracking points for identifying gestures and receiving user input corresponding to the gestures. In some implementations, the object detection and tracking device 100 may save the sequence of tracking points spanned during a gesture in a look-up table, e.g., the look-up tables 132C as described above with reference to FIG. 1. The object detection and tracking device 100 may determine a gesture made by the user based on the sequence of tracking points stored in the look-up tables 132C.

In some examples, the object detection and tracking device 100 trains the machine learning process based on images and corresponding action points for objects within the images. For example, the machine learning process may be trained using supervised learning, where a corresponding machine learning model ingests elements of an image and corresponding action points, and generates elements of output data. Further, and during training, the object detection and tracking device 100 may determine one or more losses based on the generated output data. The object detection and tracking device 100 may determine that training is complete when the one or more losses are within a threshold (e.g., less than a threshold value). For instance, the object detection and tracking device 100 may continue to train the machine learning process until the one or more losses are each below respective thresholds.

In some examples, the object detection and tracking device 100 may generate third requests for the user to perform one or more gestures to train and/or optimize the machine learning process for better detection and tracking of the hand 902. The object detection and tracking device 100 may generate the third requests for the user and display the third requests within the virtual environment of the system. For example, the object detection and tracking device 100 may request the user to make a gesture using the hand 902 (e.g., a gesture of rotating the hand 902, making a figure of one or more shapes, such as alphabets, numbers (e.g., figure of 8), or symbols. The object detection and tracking device 100 may then detect the performance of a gesture from the user in response to displaying a third request. The object detection and tracking device 100 may identify one or more points of the hand 902 that engaged in motion during the requested gesture, and adjust the plurality of action points based on the identified one or more points of the hand 902 for the requested gesture. The object detection and tracking device 100 may also identify a sequence of points in 3-D space that are spanned by the hand 902 as described herein, and use such sequence of points for updating the sequence of tracking points stored in the look-up table 132C.

In some examples, object detection and tracking device 100 may obtain, from system memory 130, hand attributes data, which may include a plurality of attributes such as palm-lines, palm-contours, shape, size of fingernails, shape of fingernails, color, multi-point hand outline geometry, and one or more identification marks. The object detection and tracking device 100 may also obtain object data (which may be angle and direction of insertion data) and user horizon of vision data (which may represent at least one view in a range of angles based on the horizon of vision of user). Object detection and tracking device 100 may generate characteristics of a hand of the user based on the hand attributes data and the user horizon of vision data, and provide the generated characteristics to train, for example, a convolutional neural network (CNN) process, a deep learning process, a decision tree process, a support vector machine process, or any other suitable machine learning process.

In one implementation, object detection and tracking device 100 may apply one or more data processing techniques to the hand attributes data and the user horizon of vision data to determine one or more parameters corresponding to a hand of a user. For example, object detection and tracking device 100 may utilize the user horizon of vision data to identify a core region of the hand of the user in the placement area. The object detection and tracking device 100 may then finely characterize the size, shape, position and orientation, etc. of the hand in the placement area based on the hand attributes data. For instance, and as described herein, the hand attributes data may characterize one or more of palm-lines, palm-contours, shape, size of fingernails, shape of fingernails, color, multi-point hand outline geometry, and one or more identification marks of a hand. Based on the hand attributes data, object detection and tracking device 100 may determine hand characteristics data for the hand, which can include one or more of a shape of the hand of the user, a position of the hand of the user, and an orientation of the hand of the user in the placement area. The object detection and tracking device 100 may output the hand characteristics data (for instance, the characteristics including the size, shape, position and orientation of the hand), and may apply one or more data processing techniques and/or correlation techniques to the hand characteristics data and angle and direction of insertion data to generate the object data. For example, object detection and tracking device 100 may correlate the angle and direction of insertion data with the position and orientation of the hand (e.g., included in the hand characteristics data) to generate the object data. In one example, the object data may characterize a plurality of values representing a position, an orientation, and a direction of insertion of an object into a placement area. The object data may further characterize whether the object is a hand of a user, which may be subsequently tracked as described herein.

Further, object detection and tracking device 100 may apply one or more trained machine learning processes, such as a trained CNN process, to the object data and hand attributes data to generate detection output data. The detection output data may identify an object (e.g., hand) inserted into a placement area of a hybrid environment (as described herein with reference to FIGS. 1-5B and 10). The object may be tracked, for example, based on detection output data.

By way of example, object detection and tracking device 100 may train a CNN process against feature values generated or obtained from a training data set that includes historical object data and hand attributes data, and object detection and tracking device 100 may compute one or more losses to determine whether the CNN process has converged. In some instances, object detection and tracking device 100 may determine one or more of a triplet loss, a regression loss, and a classification loss (e.g., cross-entropy loss), among others, based on one or more of the detection output data and the object data. For example, object detection and tracking device 100 may execute a sigmoid function that operates on the detection output data. Further, object detection and tracking device 100 may provide output generated by the executed sigmoid function as feedback to the training processes, e.g., to encourage more zeros and ones from the generated output.

Object detection and tracking device 100 may also compute a classification loss based on the detection output data and the object data. Further, object detection and tracking device 100 may provide the classification loss and the triplet loss as feedback to the training processes. Object detection and tracking device 100 may further determine whether one or more of the computed losses satisfy a corresponding threshold to determine whether the training processes have converged and the trained CNN process is available for deployment. For example, object detection and tracking device 100 may compare each computed loss to its corresponding threshold to determine if each computed loss meets or exceeds its corresponding threshold. In some examples, when each of the computed losses meet or exceed their corresponding thresholds, object detection and tracking device 100 determines the convergence of the training processes, and the training processes are complete. Further, object detection and tracking device 100 generates training loss data characterizing the computed losses, and stores training loss data within system memory 130.

In some examples, object detection and tracking device 100 may perform additional operations to determine whether the CNN process is sufficiently trained. For example, object detection and tracking device 100 may input elements of feature values generated or obtained from a validation data set that includes validation object data and hand attributes data to the CNN process to generate additional detection output data. Based on the detection output data, object detection and tracking device 100 computes one or more losses that characterize errors in detection of an object (e.g., hand) (as described above with reference to FIGS. 1-5B and 10). If the computed losses indicate that the CNN is not sufficiently trained (e.g., the one or more computed losses do not meet their corresponding thresholds), object detection and tracking device 100 continues to train the CNN (e.g., with angle and direction of insertion data, user horizon of vision data, and hand attributes data).

Although, as described, object detection and tracking device 100 trains a CNN process, one or more of any suitable processing devices associated with object detection and tracking device 100 may train the CNN process as described herein. For example, one or more servers, such as one or more cloud-based servers, may train the CNN process. In some examples, one or more processors (e.g., CPUs, GPUs) of a distributed or cloud-based computing cluster may train the CNN process. In some implementations, the CNN process may be trained by another processing device associated with object detection and tracking device 100, and the other processing device storing the configuration parameters, hyperparameters, and/or weights associated with the trained CNN process in a data repository over a network (e.g., the Internet). Further, object detection and tracking device 100 may obtain, over the network, the stored configuration parameters, hyperparameters, and/or weights, and stores them within instruction memory 132 (e.g., within detection unit 132A). Object detection and tracking device 100 may then establish the CNN process based on the configuration parameters, hyperparameters, and/or weights stored within instruction memory 132A.

In one example, the object detection and tracking device 100 implements the machine learning techniques for object detection and tracking movement of the object, such as a hand of the user, in a placement area of a hybrid environment. For instance, as described above, object detection and tracking device 100 may generate hand characteristics data, which may be further processed in combination with the angle and direction of insertion data to generate the object data that may indicate whether the detected hand corresponds to a hand of a user that should be tracked. Object detection and tracking device 100 may utilize the object data in combination with the hand attributes data and/or the angle and direction of insertion data to generate the detection output data that identifies the hand of the user in the placement area. Object detection and tracking device 100 may track the hand of the user in the placement area of the hybrid environment based on the detection output data.

In some examples, object detection and tracking device 100 may utilize data points and multi-dimensional model data to generate action points. For example, the data points may represent points that trace an image of a hand/object, and the multi-dimensional model data may represent a model defining a shape of an object. The object detection and tracking device 100 may apply one or more data processing techniques to generate action points that, in some examples, may characterize anticipated points of an object/hand in a 3-D space, where the points may move when certain gestures are made by the object/hand (as described above with reference to FIGS. 6-9 and 11). Object detection and tracking device 100 may also utilize data points, multi-dimensional model data and action points to generate object orientation data. For example, object detection and tracking device 100 may apply one or more data processing and/or correlation techniques to action points and multi-dimensional model data to identify an orientation of the object/hand in a 3-D space (as described herein with reference to FIGS. 6-9 and 11).

In one implementation, object detection and tracking device 100 may apply one or more trained machine learning processes, such as a trained CNN process, to action points, object orientation data, gesture data, multi-dimensional model data and/or data points to generate tracking points data. For example, gesture data may characterize a gesture performed by a user in response to a request for performing the gesture, e.g., a rotation, a figure of one or more alphabets, numbers, or symbols (as described above with reference to FIGS. 6-9 and 11). The object detection and tracking device 100 may apply one or more data processing and/or correlation techniques to action points, object orientation data, gesture data and the multi-dimensional model data to generate tracking points data for the hand/object corresponding to the gesture performed by the user. For example, the tracking points data may include a sequence of points in a 3-D space spanned by the hand/object during the gesture by the object/hand (as described herein with reference to FIGS. 6-9 and 11).

Further, object detection and tracking device 100 may perform operations to generate look-up tables. For instance, in some examples, object detection and tracking device 100 may apply one or more data processing and/or correlation techniques to multi-dimensional model data, object orientation data and tracking points data to generate look-up tables 132C. Look-up tables 132C may include data characterizing one or more gestures and a sequence of tracking points corresponding to each gesture (e.g., as described herein with reference to FIGS. 6-9 and 11).

In some examples, object detection and tracking device 100 may perform operations to train a CNN process to generate look-up tables 132C using multi-dimensional model data, object orientation data and tracking points data. For instance, object detection and tracking device 100 may generate features based on historical look-up tables, multi-dimensional model data, object orientation data, and tracking points data, and may input the generated features to the CNN process for training (e.g., supervised learning). The CNN may be trained to generate output data characterizing the historical look-up tables based on the features generated from the multi-dimensional model data, object orientation data, and tracking points data.

Object detection and tracking device 100 may compute one or more losses to determine whether the CNN has converged. For example, object detection and tracking device 100 may determine one or more of a triplet loss, a regression loss, and a classification loss (e.g., cross-entropy loss), among others, based on one or more of the tracking points data and look-up tables 132C. For example, object detection and tracking device 100 may execute a sigmoid function that operates on the tracking points data 1309. The sigmoid function can serve as an amplifier to enhance the spoof response generated from the CNN process. Further, object detection and tracking device 100 may provide output generated by the executed sigmoid function as feedback to the CNN process, so as to encourage more zeros and/or ones from the generated output.

Object detection and tracking device 100 may compute a classification loss based on the tracking points data and look-up tables 132C. Further, object detection and tracking device 100 may provide the classification loss and the triplet loss as feedback to the CNN process. Object detection and tracking device 100 may further determine whether one or more of the computed losses satisfy a corresponding threshold to determine whether the CNN process has converged. For example, object detection and tracking device 100 may compare each computed loss to its corresponding threshold to determine if each computed loss meets or exceeds its corresponding threshold. In some examples, when each of the computed losses meet or exceed their corresponding thresholds, object detection and tracking device 100 determines the CNN process has converged, and training is complete. Further, object detection and tracking device 100 generates training loss data characterizing the computed losses, and stores training loss data within system memory 130.

In some examples, object detection and tracking device 100 may provide additional data points characterizing a validation data set to the initially trained CNN to determine whether the initially trained CNN is sufficiently trained. For example, object detection and tracking device 100 may apply the initially trained CNN to the data points characterizing the validation data set to generate action points (e.g., an improved set of action points). For instance, object detection and tracking device 100 may apply the initially trained CNN as described herein to the action points to generate additional tracking points data. Based on the tracking points data, object detection and tracking device 100 may compute one or more losses that characterize errors in detection of a hand/object (as described herein with reference to FIGS. 6-9 and 11). If the computed losses indicate that the CNN is not sufficiently trained (e.g., the one or more computed losses do not meet their corresponding thresholds), object detection and tracking device 100 continues to train the CNN (e.g., with additional multi-dimensional model data, gesture data, object orientation data and tracking points data).

Although, as described, object detection and tracking device 100 trains the CNN process, one or more of any suitable processing devices associated with object detection and tracking device 100 may train the CNN process as described herein. For example, one or more servers, such as one or more cloud-based servers, may train CNN. In some examples, one or more processors (e.g., CPUs, GPUs) of a distributed or cloud-based computing cluster may train the CNN process. In some implementations, the CNN process may be trained by another processing device associated with object detection and tracking device 100, and the other processing device storing the configuration parameters, hyperparameters, and/or weights associated with the trained CNN process in a data repository over a network (e.g., the Internet). Further, object detection and tracking device 100 may obtain, over the network, the stored configuration parameters, hyperparameters, and/or weights, and stores them within instruction memory 132 (e.g., within detection unit 132A and/or the tracking unit 132B). Object detection and tracking device 100 may then establish CNN based on the configuration parameters, hyperparameters, and/or weights stored within instruction memory 132A and/or the tracking unit 132B.

In one example, object detection and tracking device 100 implements the machine learning techniques for detection and tracking the movement of an object/hand of the user in the placement area. As described above, object detection and tracking device 100 may generate action points and object orientation data for an object (e.g., hand), where the action points may be processed in combination with gesture data, multi-dimensional model data and/or data points, to generate tracking points data. The tracking points data may represent a sequence of points in a 3-D space spanned by the hand/object during the gesture by the object/hand. The object detection and tracking device 100 may generate look-up tables 132C based on the tracking points data as described herein. As such, the object detection and tracking device 100 can operate to detect and track an object (e.g., hand) of a user in a placement area of a hybrid environment.

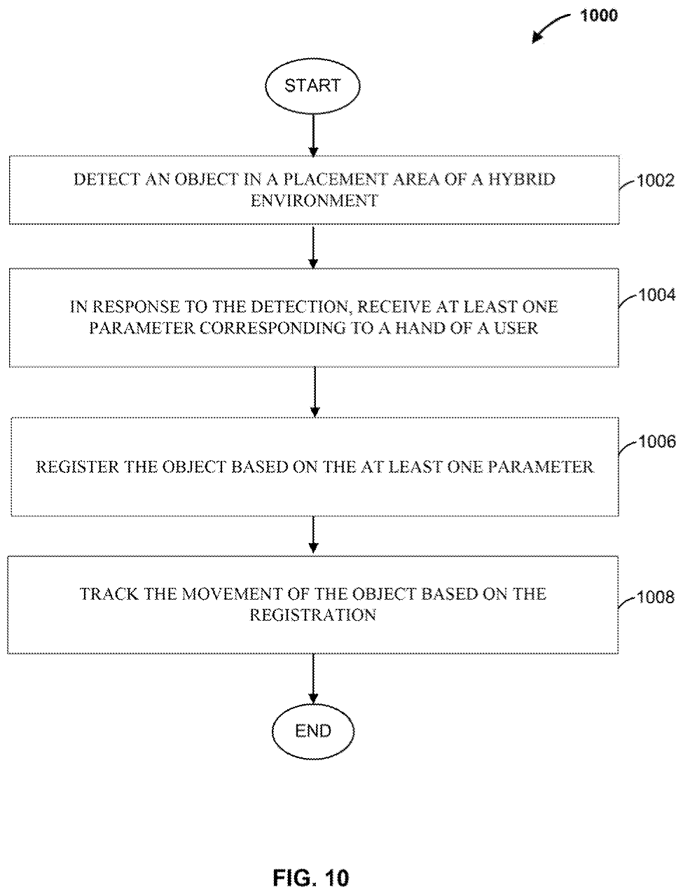

FIG. 10 is a flowchart of an exemplary process 1000 for detecting and tracking an object, according to some implementations. Process 1000 may be performed by one or more processors executing instructions locally at a computing device, such as by one or more of camera processor 114, CPU 116, and GPU 118 of object detection and tracking device 100 of FIG. 1. Accordingly, the various operations of process 1000 may be represented by executable instructions held in storage media of one or more computing platforms, such as instruction memory 132 of object detection and tracking device 100.

At block 1002, object detection and tracking device 100 detects an object in a placement area of a hybrid environment. For example, the CPU 116 of the object detection and tracking device 100 may execute instructions stored in the detection unit 132A to detect the placement of an object in a placement area of the hybrid environment. For example, the placement area may be the placement area 308 (as described above with reference to FIG. 3).

At step 1004, in response to the detection, the object detection and tracking device 100 receives at least one parameter corresponding to the hand of the user. For example, the at least one parameter may be a direction of insertion, an angle of insertion, palm-lines, palm-contours, shape, size of fingernails, shape of fingernails, color, multi-point hand outline geometry, or one or more identification marks (as described above with reference to FIGS. 3-5B). In some implementations, the camera 115 may receive the at least one parameter corresponding to the hand of the user through one or more captured images or video sequences of the hand/object of the user.

At step 1006, the object detection and tracking device 100, registers the object based on the at least one parameter. For example, the object detection and tracking device 100 may generate profile data that registers the object with a user, and may store in the profile data within system memory 130 and/or the instruction memory 132. The profile data may indicate that the object corresponding to the parameter(s) is an object of the user that will be used for providing gesture inputs.

At step 1008, the object detection and tracking device 100 tracks the movement of the object based on the registration. For example, the camera 115 may monitor the movements of the object (registered at step 1006) corresponding to the user. The camera 115 may provide one or more images and/or video sequences to the CPU 116, which may execute instructions stored in the detection unit 132A and/or the tracking unit 132B to track the movement of the registered object, as described herein.

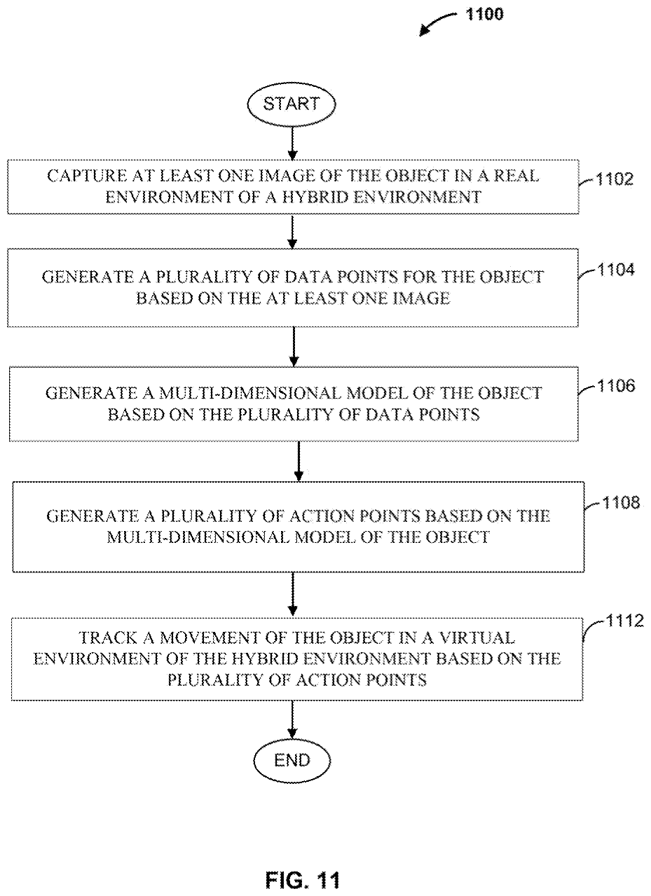

FIG. 11 is a flowchart of an exemplary process 1100 for tracking an object based on a machine learning process, according to some implementations. Process 1100 may be performed by one or more processors executing instructions locally at a computing device, such as by one or more of camera processor 114, CPU 116, and GPU 118 of object detection and tracking device 100 of FIG. 1. Accordingly, the various operations of process 1100 may be represented by executable instructions held in storage media of one or more computing platforms, such as instruction memory 132 of object detection and tracking device 100.

At block 1102, the object detection and tracking device 100 captures at least one image of the object in a real environment of a hybrid environment. For example, the camera 115 of the object detection and tracking device 100 may capture at least one image of the object in a real environment of the hybrid environment of the XR system (as described above with reference to FIGS. 1, 6-9). The camera 115 may send the captured image(s) to the CPU 116, which may perform one or more operations on the image(s) data based on the instructions stored in the instruction memory 132.

Further, at step 1104, the object detection and tracking device 100 generates a plurality of data points for the object based on the at least one image. For example, the CPU 116 may execute instructions stored in the detection unit 132A and/or the tracking unit 132B to generate the plurality of data points for the object based on the at least one image (as described above with reference to FIG. 9). The CPU 116 may store the plurality of data points for the object in the instruction memory 132 and/or the system memory 130

At block 1106, the object detection and tracking device 100 generates a multi-dimensional model of the object based on the plurality of data points. For instance, the CPU 116 may execute one or more instructions stored in the detection unit 132A and/or the tracking unit 132B to generate a 3D model of the object (as described above with reference to FIG. 9). The CPU 116 may store the multi-dimensional model of the object in the instruction memory 132 and/or the system memory 130 for further operations.

Proceeding to step 1108, the object detection and tracking device 100 may generate a plurality of action points based on the multi-dimensional model of the object. For example, CPU 116 may execute one or more instructions stored in the detection unit 132A and/or the tracking unit 132B to generate the plurality of action points (as described above with reference to FIG. 9). The plurality of action points may correspond to, for example, joints of a user's hands. The CPU 116 may store the plurality of action points for the object in the instruction memory 132 and/or the system memory 130 for further operations.

At step 1112, the object detection and tracking device 100 may track a movement of the object in a virtual environment of the hybrid environment based on the plurality of action points. For example, the CPU 116 may execute one or more instructions stored in the tracking unit 132B to track the movement of the object in a virtual environment of the hybrid environment (as described above with reference to FIG. 9). The CPU 116 may look up a sequence of tracking points and corresponding gestures stored in the look-up tables 132C to track the movement and determine the gestures corresponding of the object based on the movement.

Implementation examples are further described in the following numbered clauses:
1. An apparatus comprising:
a non-transitory, machine-readable storage medium storing instructions; and
at least one processor coupled to the non-transitory, machine-readable storage medium, the at least one processor being configured to execute instructions to:
receive image data from a camera;
detect, based on the image data, an object in a placement area of a hybrid environment, wherein the hybrid environment comprises a real environment and a virtual environment;
in response to the detection, determine a value of at least one parameter for the object;
generate profile data based on the at least one parameter value, the profile data registering the object with a user; and
track movement of the object within the hybrid environment based on the profile data.
2. The apparatus of clause 1, wherein the at least one processor is configured to execute the instructions to:
generate a request for a placement of the object in the placement area of the hybrid environment; and
display the request within the virtual environment.
3. The apparatus of any of clauses 1-2, wherein the at least one parameter comprises one or more of:
an angle of insertion into the placement area; and
a direction of insertion into the placement area.
4. The apparatus of any of clauses 1-3, wherein the processor is further configured to execute the instructions to:
determine that the at least one parameter value is disposed within a range, the range of values being based on a horizon of vision of the user; and
generate the profile data based on the determination that the at least one parameter value is disposed within the range of values.
5. The apparatus of any of clauses 1-4, the processor is further configured to execute the instructions to:
determine that the at least one parameter value is not disposed within a range of values, the range of values being based on a horizon of vision of the user; and
based on the determination that the at least one parameter value is not disposed within the range of values, display, within the hybrid environment, a request that the user insert the object into the placement area of the hybrid environment.
6. The apparatus of any of clauses 1-5, wherein the at least one processor is further configured to execute the instructions to:
generate a request that the user to insert the object into the placement area of the hybrid environment in at least one of a direction or an angle;
display the request within the hybrid environment; and
detect the object inserted into the placement area of the hybrid environment in accordance with at the at least one of the direction or the angle.
7. The apparatus of any of clauses 1-6, wherein the at least one processor is further configured to execute the instructions to:
generate a guidance image identifying one or more insertion angles for inserting the object into the placement area of the hybrid environment; and
display the guidance image within the hybrid environment.
8. The apparatus of any of clauses 1-7, wherein the object is a hand of the user.
9. The apparatus of clause 8, wherein the at least one parameter characterizes one or more attributes of the hand of the user.
10. The apparatus of clause 9, wherein the wherein the one or more attributes of the hand of the user comprise one or more of:
palm lines;
palm contours;
shape;
size of fingernails;
shape of fingernails;
color;
multi-point hand outline geometry; and
one or more identification marks.
11. The apparatus of any of clauses 1-10, wherein the hybrid environment comprises an environment of an extended reality (XR) system.
12. The apparatus of any of clauses 1-11, wherein the hybrid environment comprises an environment of a virtual reality (VR) system.
13. An apparatus comprising:
a non-transitory, machine-readable storage medium storing instructions; and
at least one processor coupled to the non-transitory, machine readable storage medium, the at least one processor being configured to execute the instructions to:
capture at least one image of an object in a real environment of a hybrid environment;
generate a plurality of data points for the object based on the at least one image;
generate a multi-dimensional model of the object based on the plurality of data points;
generate a plurality of action points based on the multi-dimensional model of the object; and
track movement of the object in a virtual environment of the hybrid environment based on the plurality of action points.
14. The apparatus of clause 13, the at least one processor being configured to execute the instructions to:
determine an orientation of the object based on the plurality of action points; and
display a virtual image of the object in the virtual environment based on the determined orientation.
15. The apparatus of any of clauses 13-14, wherein the object is one of a hand of a user and an artificial limb of the user.
16. The apparatus of any of clauses 13-16, wherein the at least one processor is further configured to execute the instructions to execute the instructions to:
generate a first request for a placement of the object in the hybrid environment;
display the first request within the virtual environment;
detect, in response to the first request, the object in the virtual environment;
generate a second request for an acknowledgement from a user that the object is a hand of the user;
display the second request within the virtual environment;
detect, in response to the second request, the acknowledgement; generate a third request for the user to perform at least one gesture; and
display the third request within the virtual environment.
17. The apparatus of clause 16, wherein the at least one gesture comprises one or a combination of:
a rotation of the hand of the user; and
a figure of one or more shapes with the hand of the user.
18. The apparatus of any of clauses 16-17, wherein the at least one processor is further configured to execute the instructions to:
detect performance of the at least one gesture in response to displaying the third request.
19. The apparatus of clause 118, wherein generating the plurality of action points is based at least in part on the at least one gesture.
20. The apparatus of clause 19, wherein the at least one processor is further configured to execute the instructions to:
estimate at least a portion of the plurality of action points based on the at least one gesture.
21. The apparatus of any of clauses 13-20, wherein the generate the plurality of tracking points is based on a look-up table, wherein the look-up table comprises a first plurality of tracking points corresponding to each of a plurality of gestures.
22. The apparatus of clause 21, wherein the at least one processor is further configured to execute the instructions to:
determine a second plurality of tracking points based on the tracked movement of the object; and
detect a gesture based on the first plurality of tracking points corresponding to each of the gestures and the second plurality of tracking points.
23. The apparatus of any of clauses 13-22, wherein the hybrid environment comprises an environment of an extended reality (XR) system.
24. The apparatus of any of clauses 13-23, wherein the hybrid environment comprises an environment of a virtual reality (VR) system.
25. A method comprising:
receiving image data from a camera;
detecting, based on the image data, an object in a placement area of a hybrid environment, wherein the hybrid environment comprises a real environment and a virtual environment;
in response to the detection, determining a value of at least one parameter for the object;
generating profile data based on the at least one parameter value, the profile data registering the object with a user; and
tracking movement of the object within the hybrid environment based on the profile data.
26. The method of clause 25, further comprising:
generating a request for a placement of the object in the placement area of the hybrid environment, wherein the hybrid environment comprises a real environment and a virtual environment; and
providing the request for display within the virtual environment.
27. The method of any of clauses 25-26, wherein the at least one parameter comprises one or more of:
an angle of insertion into the placement area; and
a direction of insertion into the placement area.
28. The method of any of clauses 25-27, wherein registering the object based on the at least one parameter comprises:
determining that the at least one parameter is within a range, wherein the range is based on a horizon of vision of a user.
29. The method of any of clauses 25-28, wherein registering the object based on the at least one parameter comprises:
determining that the at least one parameter is not within a range, wherein the range is based on a horizon of vision of a user; and
requesting the user to re-enter the object in a direction.
30. The method of any of clauses 25-29, further comprising:
generating a request for the user to enter the hand of the user within the placement area of the hybrid environment in at least one of a direction and an angle;
providing the request for display within the hybrid environment; and
detecting the hand of the user within the placement area of the hybrid environment at the at least one of the direction and the angle.
31. The method of any of clauses 25-30 further comprising, generating an insertion guidance image identifying one or more insertion angles for inserting the object into the placement area of the hybrid environment.
32. The method of any of clauses 25-31, wherein the object is a hand of a user.
33. The method of clause 32, wherein the at least one parameter characterizes one or more attributes of a hand.
34. The method of clause 33, wherein the attributes of the hand comprise one or more of:
palm-lines;
palm-contours;
shape;
size of fingernails;
shape of fingernails;
color;
multi-point hand outline geometry; and
one or more identification marks.
35. The method of any of clauses 25-34, wherein the hybrid environment comprises an environment of an extended reality (XR) system.
36. The method of any of clauses 25-35, wherein the hybrid environment comprises an environment of a virtual reality (VR) system.
37. A method comprising:
capturing at least one image of an object in a real environment of a hybrid environment;
generating a plurality of data points for the object based on the at least one image;
generating a multi-dimensional model of the object based on the plurality of data points;
generating a plurality of action points based on the multi-dimensional model of the object; and
tracking movement of the object in a virtual environment of the hybrid environment based on the plurality of action points.
38. The method of clause 37, further comprising:
determining an orientation of the object based on the plurality of action points; and
displaying a virtual image of the object in the virtual environment based on the determined orientation.
39. The method of any of clauses 37-38, wherein the object is one of a hand of a user and an artificial limb of the user.
40. The method of any of clauses 37-39, further comprising:
generating a first request for a placement of the object in the hybrid environment;
displaying the first request within the virtual environment;
detecting, in response to the first request, the object in the virtual environment;
generating a second request for an acknowledgement from a user that the object is a hand of the user;
displaying the second request within the virtual environment
detecting, in response to the second request, the acknowledgement;
generating a third request for the user to perform at least one gesture; and
displaying the third request within the virtual environment.
41. The method of clause 40, wherein the at least one gesture comprises one or a combination of:
a rotation of the hand of the user; and
a figure of one or more shapes with the hand of the user.
42. The method of any of clauses 40-41, further comprising:
detecting performance of the at least one gesture in response to displaying the third request.
43. The method of clause 42, wherein generating the plurality of action points is based at least in part on detecting the performance of the at least one gesture.
44. The method of any of clauses 40-43, comprising estimating at least a portion of the plurality of action points based on the at least one gesture.
45. The method of any of clauses 37-44, wherein generating the plurality of tracking points is based on a look-up table, wherein the look-up table comprises a first plurality of tracking points corresponding to each of a plurality of gestures.
46. The method of clause 45, further comprising:
determining a second plurality of tracking points based on the tracked movement of the object; and
detecting a gesture based on the first plurality of tracking points corresponding to each of the gestures and the second plurality of tracking points.
47. The method of any of clauses 37-46, wherein the hybrid environment comprises an environment of an extended reality (XR) system.
48. The method of any of clauses 37-47, wherein the hybrid environment comprises an environment of a virtual reality (VR) system.
49. A non-transitory, machine-readable storage medium storing instructions that, when executed by at least one processor, causes the at least one processor to perform operations that include:
receiving image data from a camera;
detecting, based on the image data, an object in a placement area of a hybrid environment, wherein the hybrid environment comprises a real environment and a virtual environment;
in response to the detection, determining a value of at least one parameter for the object;
generating profile data based on the at least one parameter value, the profile data registering the object with a user; and
tracking movement of the object within the hybrid environment based on the profile data.
50. The non-transitory, machine-readable storage medium of clause 49, wherein the operations further comprise:
generating a request for a placement of the object in the placement area of the hybrid environment; and
displaying the request within the virtual environment.
51. The non-transitory, machine-readable storage medium of any of clauses 49-50, wherein the at least one parameter comprises one or more of:
an angle of insertion into the placement area; and
a direction of insertion into the placement area.
52. The non-transitory, machine-readable storage medium of any of clauses 49-51, wherein the operations further comprise:
determining that the at least one parameter value is disposed within a range of values, the range of values being based on a horizon of vision of the user; and
generating the profile data based on the determination that the at least one parameter value is disposed within the range of values.
53. The non-transitory, machine-readable storage medium of any of clauses 49-52, wherein the operations further comprise:
determining that the at least one parameter value is not disposed within a range of values, the range of values being based on a horizon of vision of the user; and
based on the determination that the at least one parameter value is not disposed within the range of values, displaying, within the hybrid environment, a request that the user insert the object into the placement area of the hybrid environment.
54. The non-transitory, machine-readable storage medium of any of clauses 49-53, wherein the operations further comprise:
generating a request that the user insert the object into the placement area of the hybrid environment in accordance with at least one of a direction or an angle;
displaying the request within the hybrid environment; and
detecting the object inserted into the placement area of the hybrid environment in accordance with the at the at least one of the direction or the angle.
55. The non-transitory, machine-readable storage medium of any of clauses 49-54, wherein the operations further comprise:
generating a guidance image identifying one or more insertion angles for inserting the object into the placement area of the hybrid environment; and
displaying the guidance image within the hybrid environment.
56. The non-transitory, machine-readable storage medium of any of clauses 49-57, wherein the object is a hand of the user.
57. The non-transitory, machine-readable storage medium of clause 57, wherein the at least one parameter value characterizes one or more attributes of the hand of the user.
58. The non-transitory, machine-readable storage medium of clause 57, wherein the wherein the one or more attributes of the hand comprises one or more of:
palm lines;
palm contours;
shape;
size of fingernails;
shape of fingernails;
color;
multi-point hand outline geometry; and
one or more identification marks.
59. The non-transitory, machine-readable storage medium of any of clauses 49-58, wherein the hybrid environment comprises an environment of an extended reality (XR) system.
60. The non-transitory, machine-readable storage medium of any of clauses 49-59, wherein the hybrid environment comprises an environment of a virtual reality (VR) system.
61. A non-transitory, machine-readable storage medium storing instructions that, when executed by at least one processor, causes the at least one processor to perform operations that include:
capturing at least one image of an object in a real environment of a hybrid environment;
generating a plurality of data points for the object based on the at least one image;
generating a multi-dimensional model of the object based on the plurality of data points;
generating a plurality of action points based on the multi-dimensional model of the object; and
tracking movement of the object in a virtual environment of the hybrid environment based on the plurality of action points.
62. The non-transitory, machine-readable storage medium of clause 61, wherein the operations further comprise:
determining an orientation of the object based on the plurality of action points; and
displaying a virtual image of the object in the virtual environment based on the determined orientation.
63. The non-transitory, machine-readable storage medium of any of clauses 61-62, wherein the object is one of a hand of a user and an artificial limb of the user.
64. The non-transitory, machine-readable storage medium of any of clauses 61-63, wherein the operations further comprise:
displaying the first request within the virtual environment;
detecting, in response to the first request, the object in the virtual environment;
generating a second request for an acknowledgement from a user that the object is a hand of the user;
displaying the second request within the virtual environment;
detecting, in response to the second request, the acknowledgement;
generating a third request for the user to perform at least one gesture; and
displaying the third request within the virtual environment.
65. The non-transitory, machine-readable storage medium of clause 64, wherein the wherein the at least one gesture comprises one or a combination of:
a rotation of the hand of the user; and
a figure of one or more shapes with the hand of the user.
66. The non-transitory, machine-readable storage medium of any of clauses 64-65, wherein the operations further comprise:
detecting performance of the at least one gesture in response to displaying the third request.
67. The non-transitory, machine-readable storage medium of clause 66, wherein generating the plurality of action points is based at least in part on detecting the performance of the at least one gesture.
68. The non-transitory, machine-readable storage medium of any of clauses 64-67, wherein the operations further comprise estimating at least a portion of the plurality of action points based on the at least one gesture.
69. The non-transitory, machine-readable storage medium of clause 67, wherein generating the plurality of tracking points is based on a look-up table, wherein the look-up table comprises a first plurality of tracking points corresponding to each of a plurality of gestures.
70. The non-transitory, machine-readable storage medium of any of clauses 67-69, wherein the operations further comprise:
determining a second plurality of tracking points based on the tracked movement of the object; and
detecting a gesture based on the first plurality of tracking points corresponding to each of the gestures and the second plurality of tracking points.
71. The non-transitory, machine-readable storage medium of any of clauses 61-70, wherein the hybrid environment comprises an environment of an extended reality (XR) system.
72. The non-transitory, machine-readable storage medium of any of clauses 61-71, wherein the hybrid environment comprises an environment of a virtual reality (VR) system.
73. An object detection and tracking device comprising:
a means for receiving image data from a camera;
a means for detecting, based on the image data, an object in a placement area of a hybrid environment, wherein the hybrid environment comprises a real environment and a virtual environment;
in response to the detection, a means for determining a value of at least one parameter for the object;
a means for generating profile data based on the at least one parameter value, the profile data registering the object with a user; and
a means for tracking movement of the object within the hybrid environment based on the profile data.
74. The object detection and tracking device of clause 73, further comprising:
a means for generating a request for a placement of the object in the placement area of the hybrid environment; and
a means for displaying the request within the virtual environment.
75. The object detection and tracking device of any of clauses 73-74, wherein the at least one parameter comprises one or more of:
an angle of insertion into the placement area; and
a direction of insertion into the placement area.
76. The object detection and tracking device of any of clauses 73-75, further comprising:
a means for determining that the at least one parameter value is disposed within a range of values, the range of values being based on a horizon of vision of the user; and
a means for generating the profile data based on the determination that the at least one parameter value is disposed within the range of values.
77. The object detection and tracking device of any of clauses 73-76, further comprising:
a means for determining that the at least one parameter value is not disposed within a range of values, the range of values being based on a horizon of vision of the user; and
based on the determination that the at least one parameter value is not disposed within the range of values, a means for displaying, within the hybrid environment, a request that the user insert the object into the placement area of the hybrid environment.
78. The object detection and tracking device of any of clauses 73-77, further comprising:
a means for generating a request that the user insert the object into the placement area of the hybrid environment in accordance with at least one of a direction or an angle;
a means for displaying the request within the hybrid environment; and
a means for detecting the object inserted into the placement area of the hybrid environment in accordance with the at the at least one of the direction or the angle.
79. The object detection and tracking device of any of clauses 73-78, further comprising:
a means for generating a guidance image identifying one or more insertion angles for inserting the object into the placement area of the hybrid environment; and
a means for displaying the guidance image within the hybrid environment.
80. The object detection and tracking device of any of clauses 73-79, wherein the object is a hand of the user.
81. The object detection and tracking device of clause 80, wherein the at least one parameter value characterizes one or more attributes of the hand of the user.
82. The object detection and tracking device of clause 80, wherein the attributes of the hand comprise one or more of:
palm lines;
palm contours;
shape;
size of fingernails;
shape of fingernails;
color;
multi-point hand outline geometry; and
one or more identification marks.
83. The object detection and tracking device of any of clauses 73-82, wherein the hybrid environment comprises an environment of an extended reality (XR) system.
84. The object detection and tracking device of any of clauses 73-83, wherein the hybrid environment comprises an environment of a virtual reality (VR) system.
85. An object detection and tracking device comprising:
a means for capturing at least one image of an object in a real environment of a hybrid environment;
a means for generating a plurality of data points for the object based on the at least one image;
a means for generating a multi-dimensional model of the object based on the plurality of data points;
a means for generating a plurality of action points based on the multi-dimensional model of the object; and
a means for tracking movement of the object in a virtual environment of the hybrid environment based on the plurality of action points.
86. The object detection and tracking device of clause 85, further comprising:
a means for determining an orientation of the object based on the plurality of action points; and
a means for displaying a virtual image of the object in the virtual environment based on the determined orientation.
87. The object detection and tracking device of any of clauses 85-86, wherein the object is one of a hand of a user and an artificial limb of the user.
88. The object detection and tracking device of any of clauses 85-87, further comprising:
a means for generating a first request for a placement of the object in the hybrid environment;
a means for displaying the first request within the virtual environment;
a means for detecting, in response to the first request, the object in the virtual environment;
a means for generating a second request for an acknowledgement from a user that the object is a hand of the user;
a means for displaying the second request within the virtual environment;
a means for detecting, in response to the second request, the acknowledgement;
a means for generating a third request for the user to perform at least one gesture; and
a means for displaying the third request within the virtual environment.
89. The object detection and tracking device of clause 88, wherein the at least one gesture comprises one or a combination of:
a rotation of the hand of the user; and
a figure of one or more shapes with the hand of the user
90. The object detection and tracking device of any of clauses 88-89, further comprising:
a means for detecting performance of the at least one gesture in response to displaying the third request.
91. The object detection and tracking device of clause 90, wherein generating the plurality of action points is based at least in part on detecting the performance of the at least one gesture.
92. The object detection and tracking device of any of clauses 88-91, further comprising estimating at least a portion of the plurality of action points based on the at least one gesture.
93. The object detection and tracking device of any of clauses 85-92, wherein generating the plurality of tracking points is based on a look-up table, wherein the look-up table comprises a first plurality of tracking points corresponding to each of a plurality of gestures.
94. The object detection and tracking device of any of clauses 85-93, further comprising:
a means for determining a second plurality of tracking points based on the tracked movement of the object; and
a means for detecting a gesture based on the first plurality of tracking points corresponding to each of the gestures and the second plurality of tracking points.
95. The object detection and tracking device of any of clauses 85-94, wherein the hybrid environment comprises an environment of an extended reality (XR) system.
96. The object detection and tracking device of any of clauses 85-95, wherein the hybrid environment comprises an environment of a virtual reality (VR) system.

Although the methods described above are with reference to the illustrated flowcharts, many other ways of performing the acts associated with the methods may be used. For example, the order of some operations may be changed, and some embodiments may omit one or more of the operations described and/or include additional operations.

Further, although the exemplary embodiments described herein are, at times, described with respect to an object detection and tracking device, the machine learning processes, as well as the training of those machine learning processes, may be implemented by one or more suitable devices. For example, in some examples, an object detection and tracking device may capture an image or video sequence and may transmit the image to a distributed or cloud computing system. The distributed or cloud computing system may apply the trained machine learning processes described herein to track the movement of the object.

Additionally, the methods and system described herein may be at least partially embodied in the form of computer-implemented processes and apparatus for practicing those processes. The disclosed methods may also be at least partially embodied in the form of tangible, non-transitory machine-readable storage media encoded with computer program code. For example, the methods may be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, computer program code segments configure the processor to create specific logic circuits. The methods may alternatively be at least partially embodied in application specific integrated circuits for performing the methods.

We claim:

1. A method, comprising:
receiving image data from a camera;
detecting, based on the image data, an object in a placement area of a hybrid environment, wherein the hybrid environment comprises a real environment and a virtual environment;
in response to the detection, determining a value of at least one parameter for the object;
generating profile data based on the at least one parameter value, the profile data registering the object with a user; and
tracking movement of the object within the hybrid environment based on the profile data.

2. The method of claim 1, further comprising:
generating a request for a placement of the object in the placement area of the hybrid environment; and
displaying the request within the virtual environment.

3. The method of claim 1, wherein the at least one parameter value comprises one or more of:
an angle of insertion into the placement area; and
a direction of insertion into the placement area.

4. The method of claim 1, wherein further comprising:
determining that the at least one parameter value is disposed within a range of values, the range of values being based on a horizon of vision of the user; and
generating the profile data based on the determination that the at least one parameter value is disposed within the range of values.

5. The method of claim 1, further comprising:
determining that the at least one parameter value is not disposed within a range of values, the range of values being based on a horizon of vision of the user; and
based on the determination that the at least one parameter value is not disposed within the range of values, displaying, within the hybrid environment, a request that the user insert the object into the placement area of the hybrid environment.

6. The method of claim 1, further comprising:
generating a request that the user insert the object into the placement area of the hybrid environment in accordance with at least one of a direction or an angle;
displaying the request within the hybrid environment; and
detecting the object inserted into the placement area of the hybrid environment in accordance with the at the at least one of the direction or the angle.

7. The method of claim 1 further comprising:
generating a guidance image identifying one or more insertion angles for inserting the object into the placement area of the hybrid environment; and
displaying the guidance image within the hybrid environment.

8. The method of claim 1, wherein the object is a hand of the user.

9. The method of claim 8, wherein the at least one parameter value characterizes one or more attributes of the hand of the user.

10. The method of claim 9, wherein the one or more attributes of the hand of the user comprises one or more of:
palm lines;
palm contours;
shape;
size of fingernails;
shape of fingernails;
color;
multi-point hand outline geometry; and
one or more identification marks.

11. The method of claim 1, wherein the hybrid environment comprises an environment of an extended reality (XR) system.

12. The method of claim 1, wherein the hybrid environment comprises an environment of a virtual reality (VR) system.

13. A method, comprising:
capturing at least one image of an object in a real environment of a hybrid environment;
generating a plurality of data points for the object based on the at least one image;
generating a multi-dimensional model of the object based on the plurality of data points;
generating a plurality of action points based on the multi-dimensional model of the object; and
tracking movement of the object in a virtual environment of the hybrid environment based on the plurality of action points.

14. The method of claim 13, further comprising:
determining an orientation of the object based on the plurality of action points; and
displaying a virtual image of the object in the virtual environment based on the determined orientation.

15. The method of claim 13, wherein the object is one of a hand of a user and an artificial limb of the user.

16. The method of claim 13, further comprising:
generating a first request for a placement of the object in the hybrid environment;
displaying the first request within the virtual environment;
detecting, in response to the first request, the object in the virtual environment;
generating a second request for an acknowledgement from a user that the object is a hand of the user;
displaying the second request within the virtual environment;
detecting, in response to the second request, the acknowledgement;
generating a third request for the user to perform at least one gesture; and
displaying the third request within the virtual environment.

17. The method of claim 16, wherein the at least one gesture comprises one or a combination of:
a rotation of the hand of the user; and
a figure of one or more shapes with the hand of the user.

18. The method of claim 16, further comprising
detecting performance of the at least one gesture in response to displaying the third request.

19. The method of claim 18, wherein generating the plurality of action points is based at least in part on detecting the performance of the at least one gesture.

20. The method of claim 19 further comprising estimating at least a portion of the plurality of action points based on the at least one gesture.

21. The method of claim 13, wherein generating the plurality of tracking points is based on a look-up table, wherein the look-up table comprises a first plurality of tracking points corresponding to each of a plurality of gestures.

22. The method of claim 21, further comprising:
determining a second plurality of tracking points based on the tracked movement of the object; and
detecting a gesture based on the first plurality of tracking points corresponding to each of the gestures and the second plurality of tracking points.

23. The method of claim 13, wherein the hybrid environment comprises an environment of an extended reality (XR) system.

24. The method of claim 13, wherein the hybrid environment comprises an environment of a virtual reality (VR) system.

25. An apparatus, comprising:
a non-transitory, machine-readable storage medium storing instructions; and
at least one processor coupled to the non-transitory, machine-readable storage medium, the at least one processor being configured to:
receive image data from a camera;
detect, based on the image data, an object in a placement area of a hybrid environment, wherein the hybrid environment comprises a real environment and a virtual environment;
in response to the detection, determine a value of at least one parameter for the object;
generate profile data based on the at least one parameter value, the profile data registering the object with a user; and
track movement of the object within the hybrid environment based on the profile data.

26. The apparatus of claim 25, wherein the at least one processor is configured to:
generate a request for a placement of the object in the placement area of the hybrid environment; and
display the request within the virtual environment.

27. An apparatus, comprising:
a non-transitory, machine-readable storage medium storing instructions; and
at least one processor coupled to the non-transitory, machine-readable storage medium, the at least one processor being configured to:
capture at least one image of an object in a real environment of a hybrid environment;
generate a plurality of data points for the object based on the at least one image;
generate a multi-dimensional model of the object based on the plurality of data points;
generate a plurality of action points based on the multi-dimensional model of the object; and
track a movement of the object in a virtual environment of the hybrid environment based on the plurality of action points.

28. The apparatus of claim 27, wherein the at least one processor is configured to:
determine an orientation of the object based on the plurality of action points; and
display a virtual image of the object in the virtual environment based on the determined orientation.

29. A non-transitory, machine-readable storage medium storing instructions that, when executed by at least one processor, causes the at least one processor to perform operations that include:
receiving image data from a camera;
detecting, based on the image data, an object in a placement area of a hybrid environment, wherein the hybrid environment comprises a real environment and a virtual environment;
in response to the detection, determining a value of at least one parameter for the object;
generating profile data based on the at least one parameter value, the profile data registering the object with a user; and
tracking movement of the object within the hybrid environment based on the profile data.

30. A non-transitory, machine-readable storage medium storing instructions that, when executed by at least one processor, causes the at least one processor to perform operations that include:
capturing at least one image of an object in a real environment of a hybrid environment;
generating a plurality of data points for the object based on the at least one image;
generating a multi-dimensional model of the object based on the plurality of data points;
generating a plurality of action points based on the multi-dimensional model of the object; and
tracking a movement of the object in a virtual environment of the hybrid environment based on the plurality of action points.
